(19) United States
(12) Patent Application Publication
(10) Pub. No.: US 2025/0111258 A1
(43) Pub. Date: Apr. 3, 2025

(54) ERROR MITIGATED NETWORKS OF FEED-FORWARD OPERATIONS

(71) Applicant: International Business Machines Corporation, Armonk, NY (US)

(72) Inventors: Daniel Josef Egger, Zurich (CH); Almudena Carrera Vazquez, Thalwil (CH); Caroline Tornow, Zurich (CH); Stefan Woerner, Zurich (CH)

(21) Appl. No.: 18/477,873

(22) Filed: Sep. 29, 2023

(51) Int. Cl. G06N 10/20; G06N 10/70

(52) U.S. Cl. CPC G06N 10/20; G06N 10/70

(57) ABSTRACT

A system can comprise a memory that can store computer-executable components and a processor that can execute the computer-executable components stored in the memory, wherein the computer-executable components can comprise a circuit transpiler unit that can identify respective placement of one or more mid-circuit measurements and one or more classically controlled feed-forward operations on a quantum circuit. The computer-executable components can further comprise a circuit transpiler unit that can identify respective placement of one or more mid-circuit measurements and one or more classically controlled feed-forward operations on a quantum circuit. The computer-executable components can further comprise a circuit twirling unit that can create twirled layers of circuit instructions by twirling respective classical bits controlling the one or more classically controlled feed-forward operations. The computer-executable components can further comprise a noise learning unit that can learn a noise model of the circuit instructions based on a rank deficient Pauli transfer matrix.

### BACKGROUND

The subject disclosure relates to quantum computing, and more specifically to error mitigated networks of feed-forward operations.

Quantum computing is generally the use of quantum-mechanical phenomena for the purpose of performing computing and information processing functions. Quantum computing can be viewed in contrast to classical computing, which generally operates on binary values with transistors. That is, while classical computers can operate on bit values that are either 0 or 1, quantum computers operate on quantum bits that comprise superpositions of both 0 and 1, can entangle multiple quantum bits, and use interference. Quantum computers can comprise a group of qubits that can perform quantum operations on data. Quantum computers can manipulate qubits using quantum gates that can be applied to the qubits. Virtual quantum gates can be implemented by teleporting quantum gates to allow quantum computers to communicate only through classical communication, however, teleportation circuits can produce unwanted noise and be expensive to implement.

The above-described background description is merely intended to provide a contextual overview regarding quantum computing and virtual quantum gates, and is not intended to be exhaustive.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable error mitigated networks of feed-forward operations are discussed.

According to an embodiment, a system is provided. The system can comprise a memory that can store computer-executable components. The system can further comprise a processor that can execute the computer-executable components stored in the memory, where the computer-executable components can comprise a circuit transpiler unit that can identify respective placement of one or more mid-circuit measurements (or MCMs) and one or more classically controlled feed-forward operations on a quantum circuit to generate an optimized quantum circuit. The computer-executable components can further comprise a circuit twirling unit that can create twirled layers of circuit instructions based on the optimized quantum circuit by twirling respective classical bits that control the one or more classically controlled feed-forward operations. The computer-executable components can further comprise a noise learning unit that can learn a noise model of the twirled layers of circuit instructions based on a rank deficient Pauli transfer matrix to learn noise generated in the optimized quantum circuit. Such embodiments of the system can provide a number of advantages, including reducing error in feed-forward networks of conditional gates in larger quantum circuits towards implementation of virtual quantum gates (hereinafter, virtual gates) using local operations and classical communication (LOCC).

In one or more embodiments of the aforementioned system, the circuit transpiler unit can adapt a plurality of quantum gates and one or more classically controlled instructions of the quantum circuit to a hardware that executes the plurality of quantum gates and the one or more classically controlled instructions. Adapting the plurality of quantum gates to the hardware can comprise converting, with local operations, a classically controlled Z gate to a classically controlled X gate or converting the classically controlled X gate to the classically controlled Z gate. In one or more embodiments of the aforementioned system, the twirled layers of circuit instructions can comprise a plurality of mid-circuit measurements, a plurality of quantum gates and a plurality of feed-forward gates, and the circuit twirling unit can use a set of twirling rules to twirl the respective classical bits that control the one or more classically controlled feed-forward operations. In one or more embodiments of the aforementioned system, the set of twirling rules can use the respective classical bits that control the one or more classically controlled feed-forward operations to ensure that one or more twirled classically controlled feed-forward operations can have a logical effect as that of the one or more classically controlled feed-forward operations without twirling. In one or more embodiments of the aforementioned system, a dynamical decoupling pulse sequence insertion unit can insert a dynamical decoupling pulse sequence during an idle duration and a context-switching duration of the quantum circuit. In one or more embodiments of the aforementioned system, the dynamical decoupling pulse sequence insertion unit can insert the dynamical decoupling pulse sequence during the idle duration of the quantum circuit based on a sequence of dynamical decoupling gates. In one or more embodiments of the aforementioned system, the learning of the noise model of the circuit instructions based on the rank deficient Pauli transfer matrix can be performed via a Lasso regularization technique, where the Lasso regularization technique can be employed to minimize a strength of a generator that can model noise in one or more circuit instructions. Such embodiments of the system can provide a number of advantages, including reducing error in feed-forward networks of conditional gates in larger quantum circuits towards implementation of virtual gates using LOCC, mitigating negative effects of lengthy measurements and context switches involved in implementing the virtual gates, and reduction in a cost of implementing the error mitigated virtual gates using LOCC.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can generate error mitigated networks of conditional gates to enable virtual gates via LOCC in accordance with one or more embodiments described herein.

FIG. 2 illustrates a diagram of an example, non-limiting teleportation of a Controlled Not (CNOT) gate in accordance with one or more embodiments described herein.

FIG. 3 illustrates a diagram of an example, non-limiting teleportation of a controlled single-qubit rotation in accordance with one or more embodiments described herein.

FIG. 4 illustrates a diagram of an example, non-limiting quantum circuit for teleportation of a controlled single-qubit rotation and idle times of qubits in accordance with one or more embodiments described herein.

FIG. 5 illustrates a diagram of an example, non-limiting representation of cut Bell pairs and consumption of the cut Bell pairs in accordance with one or more embodiments described herein.

FIG. 6 illustrates a diagram of an example, non-limiting quantum circuit comprising gates that can be teleported in accordance with one or more embodiments described herein.

FIG. 7 illustrates a diagram of an example, non-limiting quantum circuit that can be optimized for teleportation of quantum gates in accordance with one or more embodiments described herein.

FIG. 8 illustrates a diagram of the example, non-limiting quantum circuit of FIG. 7 identifying consecutive measurement blocks in the quantum circuit in accordance with one or more embodiments described herein.

FIG. 9 illustrates another diagram of the example, non-limiting quantum circuit of FIG. 7 identifying a classically controlled Z gate and a CNOT gate in the quantum circuit in accordance with one or more embodiments described herein.

FIG. 10 illustrates a diagram of an example, non-limiting quantum circuit identifying a classically controlled Z gate commuted past a CNOT gate in accordance with one or more embodiments described herein.

FIG. 11 illustrates diagrams of example, non-limiting conversions of conditional X and Z gates using Hadamard gates in accordance with one or more embodiments described herein.

FIG. 12 illustrates a diagram of an example, non-limiting portion of a quantum circuit with pre-gates and post-gates that can be implemented to perform Pauli twiring in accordance with one or more embodiments described herein.

FIG. 13 illustrates diagrams of example, non-limiting quantum circuits demonstrating Pauli twirling without changing a value of a classical bit in accordance with one or more embodiments described herein.

FIG. 14 illustrates diagrams of example, non-limiting quantum circuits demonstrating Pauli twirling by changing a value of a classical bit in accordance with one or more embodiments described herein.

FIG. 15 illustrates diagrams of example, non-limiting quantum circuits before and after twirling of a classical conditional associated with the quantum circuit in accordance with one or more embodiments described herein.

FIG. 16 illustrates diagrams of example, non-limiting quantum circuits demonstrating Pauli twirling by application of a post-gate in accordance with one or more embodiments described herein.

FIG. 17 illustrates a diagram of an example, non-limiting quantum circuit demonstrating Pauli twirling via a split twirl in accordance with one or more embodiments described herein.

FIG. 18 illustrates a diagram of an example, non-limiting quantum circuit identifying measurements that can be performed in parallel for enabling virtual gates with LOCC in accordance with one or more embodiments described herein.

FIG. 19 illustrates a diagram of an example, non-limiting quantum circuit showing pre-gates and twirls that can be used to determine post-gates in accordance with one or more embodiments described herein.

FIG. 20 illustrates a diagram of an example, non-limiting quantum circuit in accordance with one or more embodiments described herein.

FIG. 21 illustrates diagrams of example, non-limiting representations of Clifford equivalent circuits in accordance with one or more embodiments described herein.

FIG. 22 illustrates diagrams of example, non-limiting quantum circuits comprising a circuit with a network of mid-circuit measurements and classically controlled X gates and a Clifford equivalent circuit of the circuit with the mid-circuit measurements and the classically controlled X gates in accordance with one or more embodiments described herein.

FIG. 23 illustrates a diagram of an example, non-limiting representation of performing dynamical decoupling in a quantum circuit in accordance with one or more embodiments described herein.

FIG. 24 illustrates diagrams of example, non-limiting Pauli transfer matrices that can be used for learning a noise model of circuit instructions in accordance with one or more embodiments described herein.

FIG. 25 illustrates a diagram of an example, non-limiting representation of quantum computing via classical communication in accordance with one or more embodiments described herein.

FIG. 26 illustrates a flow diagram of an example, non-limiting method that can generate error mitigated networks of conditional gates to enable virtual gates via LOCC in accordance with one or more embodiments described herein.

FIG. 27 illustrates another flow diagram of an example, non-limiting method that can generate error mitigated networks of conditional gates to enable virtual gates via LOCC in accordance with one or more embodiments described herein.

FIG. 28 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Quantum gates can be teleported with LOCC, and a quantum circuit can enable teleportation of the quantum gates by consuming Bell pairs to create virtual gates via LOCC. LOCC can refer to a quantum computing architecture capable of executing virtual gates built from local operations (e.g., single-qubit gates and measurements) and classical communication (e.g., a quantum gate classically controlled by the outcome of a measurement done on a qubit). To perform gate virtualization with LOCC instead of local operations (LO), multiple cut Bell pairs can be generated by a Bell pair factory, wherein a Bell pair can comprise a Hadamard gate followed by a CNOT gate, and a cut Bell pair can indicate a Bell pair implemented with quasi-probability decomposition. However, there can be a time delay between production of the cut Bell pairs and consumption of the cut Bell pairs. For example, Bell pairs can be produced together, however, not all Bell pairs can be consumed at once, and several Bell pairs can idle until consumed. The time delay can lead to errors building up on the Bell pairs, and the Bell pairs can need protection against noise. Further, teleporting quantum gates can involve resource intensive operations that can introduce error, such as multiple local CNOT gates (˜1% error, ˜300 ns), multiple measurements (˜1-5% error, ˜0.5 to 1 μs) and controlled gates (2-6% error, including the measurement error plus a 1% error, and ˜0.5 to 1 μs latency). Error can also be introduced by idling qubits. While LOCC can provide significant gains over LO (e.g., a shot overhead of LOCC methods can scale as O(4ⁿ) asymptotically in the limit of generating many Bell pairs, whereas with LO only, the cost can be O(9ⁿ) for n teleported gates), gate teleportation can be expensive. Some existing techniques can provide methods of mitigating a single mid-circuit measurement with probabilistic error cancellation (PEC). However, as discussed above, virtual gates implemented via LOCC can utilize multiple cut Bell pairs and mid-circuit measurements with feed-forward operations that can introduce long latencies (compared to an energy relaxation time T₁; T₁/T₂ times can be ˜300 μs, with T₂ being a dephasing time of a qubit). The delays can introduce an increase in γ, wherein γ can measure a sampling overhead associated with a quasi-probability decomposition used to implement a probabilistic cancellation of error in a quantum circuit. Stated differently, γ can measure a cost of error mitigation associated with a quasi-probability decomposition used to implement PEC in a quantum circuit. In addition, a quantum circuit for teleporting the quantum gates (e.g., a teleportation circuit) can involve multiple costly operations such as conditional gates.

Various embodiments of the present disclosure can be implemented to produce a solution to these problems. For example, since LOCC can perform multiple cut gates and poor transpilation can exacerbate lengthy measurements and context switches, various embodiments discussed herein can use a classical-conditional aware transpiler to place as many mid-circuit measurements and context switches as possible in parallel, to mitigate effects of the lengthy measurements and context switches. In some embodiments, states of idling Bell pairs can be stabilized and error mitigated, for example, via PEC. In one or more embodiments, the increase in γ can be mitigated with dynamical decoupling. In addition, since mid-circuit measurements can introduce more error, an efficient PEC with lasso regression can be implemented to further mitigate the increase in γ.

More specifically, embodiments described herein include systems, computer-implemented methods, and computer program products that can execute virtual gates with LOCC by considering transpiler optimizations to reduce context switching and schedule duration in a network of error mitigated mid-circuit measurements, considering twirling of classical bits in classically controlled quantum gates, realizing that a Pauli-transfer matrix of a noise model can be rank deficient and introducing a special handling of the optimization that can learn the noise model, and utilizing dynamical decoupling (or DD) to reduce the cost of the error mitigation. For example, a quantum computing system for executing virtual gates with LOCC can comprise a circuit transpiler unit to optimize the placement of mid-circuit measurements and classically controlled feed-forward operations. The circuit transpiler unit can optimize quantum gates and classically controlled instructions to a hardware that can execute the quantum gates and classically controlled instructions. The quantum computing system can further comprise a circuit twirling unit to create twirled layers of circuit instructions comprising multiple mid-circuit measurements, quantum gates, and feed-forward gates. Twirling rules implemented by the circuit twirling unit can twirl the classical bits that control the feed-forward operations, and the twirling rules can utilize the classical bits that control the feed-forward operations as post-gates to ensure that the twirled classically controlled feed-forward operations have the same logical effect as the classically controlled feed-forward operations without twirling. The quantum computing system can further comprise a dynamical decoupling pulse sequence insertion unit that can insert dynamical decoupling pulse sequences in idle times and context switching times of the circuit. The dynamical decoupling pulse sequence insertion unit can insert dynamical decoupling pulse sequences in the idle times of a quantum circuit in a manner that can depend on operations performed on non-idling qubits. The quantum computing system can further comprise a noise learning model for circuit instructions with a rank-deficient Pauli transfer matrix. Noise learning of the circuit instructions with the rank-deficient Pauli transfer matrix can be performed using Lasso regularization to minimize a strength of the generators that can model the noise in the circuit instruction.

In one or more embodiments, a computer-implemented method can comprise receiving a quantum circuit on a plurality of qubits, creating a modified quantum circuit from the quantum circuit by arranging at least two mid-circuit measurements on at least two qubits to occur coincidentally, determining a plurality of twirling circuits for unmeasured circuits, inserting the plurality of twirling circuits into the modified quantum circuit to create an executable quantum circuit, and performing the quantum circuit on a quantum computer. The at least two qubits can comprise virtual qubits encoded over multiple physical qubits.

Improvements provided by the various embodiments of the present disclosure can reduce a cost/overhead of implementing error mitigated virtual gates with LOCC. The error mitigated virtual gates can be implemented behind primitives and abstracted away from users. Gate teleportation with LOCC can further enable modular quantum computers wherein multiple smaller quantum processing units (QPUs) can function as one big QPU. Various embodiments discussed herein can ultimately enable execution of large quantum circuits on modular quantum computing systems.

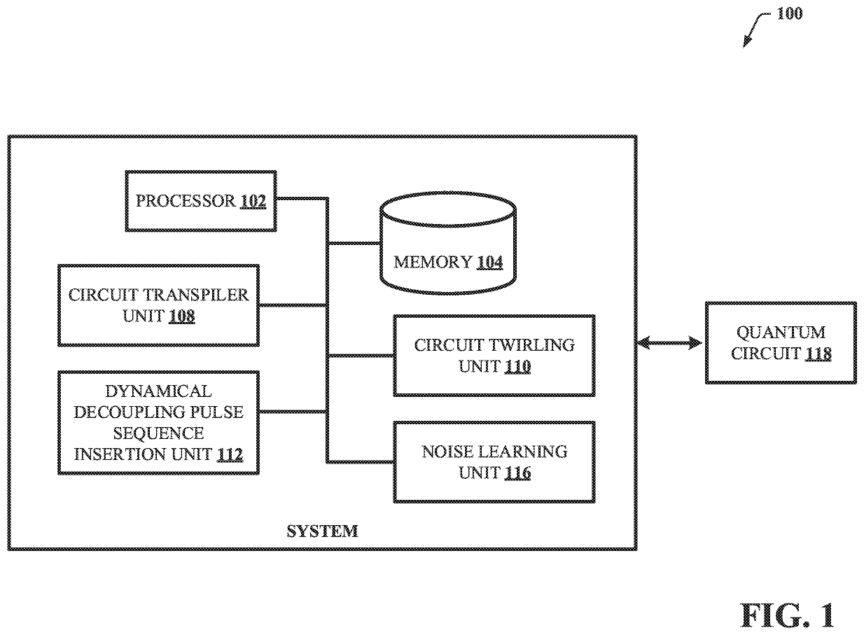

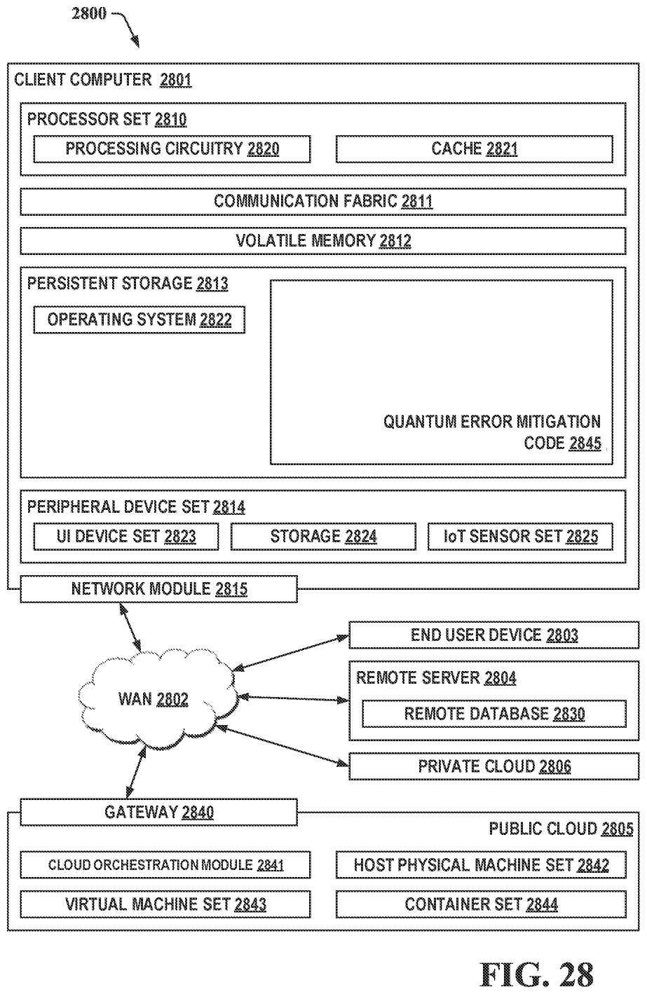

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 (or system 100) as illustrated at FIG. 1, and/or systems thereof, can further comprise, be associated with and/or be coupled to one or more computer and/or computing-based elements described herein with reference to an operating environment, such as the operating environment 2800 illustrated at FIG. 28. For example, system 100 can be associated with, such as accessible via, a computing environment 2800 described below with reference to FIG. 28, such that aspects of processing can be distributed between system 100 and the computing environment 2800. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can generate error mitigated networks of conditional gates to enable virtual gates via LOCC in accordance with one or more embodiments described herein. In one or more embodiments, system 100 can be operably coupled to quantum circuit 118, wherein quantum circuit 118 can be teleportation circuit that can execute virtual gates via LOCC.

System 100 and/or the components of system 100 can be employed to use hardware and/or software to solve problems that are highly technical in nature (e.g., related to quantum computing, executing virtual gates via LOCC, etc.), that are not abstract and that cannot be performed as a set of mental acts by a human. Further, some of the processes performed may be performed by specialized computers for carrying out defined tasks related to executing the virtual gates with LOCC. The system 100 and/or components of the system can be employed to solve new problems that arise through advancements in quantum computing technologies mentioned above, computer architecture, and/or the like. The system 100 can provide technical improvements to quantum computing systems by reducing error in feed-forward networks of conditional gates in quantum circuits generated for teleporting quantum gates, which can contribute towards development of modular quantum computers wherein multiple smaller QPUs can communicate via classical communication to function as a single large QPU. Further advantages can comprise a reduction in a cost of implementing error mitigated virtual gates with LOCC.

Discussion turns briefly to processor 102 and memory 104 of system 100. For example, in one or more embodiments, system 100 can comprise processor 102 (e.g., computer processing unit, microprocessor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to processor 102. Memory 104 can store computer-executable instructions that, upon execution by processor 102, can cause processor 102 and/or one or more other components of system 100 (e.g., circuit transpiler unit 108, circuit twirling unit 110, dynamical decoupling pulse sequence insertion unit 112, and/or noise learning unit 116) to perform one or more actions. In one or more embodiments, memory 104 can store the computer-executable components (e.g., circuit transpiler unit 108, circuit twirling unit 110, dynamical decoupling pulse sequence insertion unit 112, and/or noise learning unit 116).

The one or more computer and/or machine readable, writable and/or executable components and/or instructions, when executed by processor 102, can enable performance of one or more operations defined by such component(s) and/or instruction(s). For example, circuit transpiler unit 108 can identify respective placement of one or more mid-circuit measurements and one or more classically controlled feed-forward operations on quantum circuit 118 to generate an optimized quantum circuit (e.g., optimized quantum circuit 118), wherein identifying the respective placement can comprise identifying optimal respective placement of the one or more mid-circuit measurements and the one or more classically controlled feed-forward operations. For example, circuit transpiler unit 108 can identify networks of conditional gates and place as many mid-circuit measurements in parallel as can be executed in parallel in quantum circuit 118 to optimize quantum circuit 118. Execution of a quantum circuit can feature more than one virtual gate (e.g., virtual LOCC gate). However, conditional gates can be time consuming due to context switching, and placing mid-circuit measurements in parallel can minimize a context switching time. Context switching can refer to a phenomenon wherein based on a measurement taken by a measurement gate, one or more operations that can follow the measurement can be decided. The process of deciding on the type of operation that can follow a measurement can be time consuming. Thus, placing mid-circuit measurements in parallel can minimize the context switching time. In an embodiment, circuit transpiler unit 108 can elect to convert a conditional basis to a hardware-friendly representation. For example, circuit transpiler unit 108 can convert a conditional X gate to a conditional Z gate and vice-versa. That is, circuit transpiler unit 108 can adapt a plurality of quantum gates and one or more classically controlled instructions in quantum circuit 118 to a hardware that can execute the plurality of quantum gates and the one or more classically controlled instructions. Adapting the plurality of quantum gates to the hardware can comprise converting a classically controlled Z gate to a classically controlled X gate or converting the classically controlled X gate to the classically controlled Z gate using Hadamard gates.

Upon reorganization/optimization of quantum circuit 118 by circuit transpiler unit 108, error mitigation can be implemented into the optimized quantum circuit (e.g., the optimized quantum circuit 118) via PEC. Operations for performing PEC can involve twirling of the mid-circuit measurements and classical conditionals, wherein the twirling can be performed using a set of twirling rules or extra logic. In one or more embodiments, circuit twirling unit 110 can create twirled layers of circuit instructions comprising a plurality of mid-circuit measurements, a plurality of quantum gates and a plurality of feed-forward gates. Circuit twirling unit 110 can create twirled layers of circuit instructions based on the optimized quantum circuit by twirling respective classical bits that control the one or more classically controlled feed-forward operations. Circuit twirling unit 110 can use a set of twirling rules to twirl the respective classical bits that can control the one or more classically controlled feed-forward operations. In an embodiment, the set of twirling rules can utilize the classical bits that control the one or more classically controlled feed-forward operations to ensure that one or more twirled classically controlled feed-forward operations have a logical effect as that of the one or more classically controlled feed-forward operations without twirling. That is, the set of twirling rules can use the classical bits that control the one or more classically controlled feed-forward operations to ensure that the one or more twirled classically controlled feed-forward operations have the same logical effect as that of one or more untwirled classically controlled feed-forward operations.

Further, circuit twirling unit 110 can determine twirling circuits based on knowledge of a relationship between measured qubits, classical bits, and qubits with conditional gates. For example, based on the relationship between the measured qubits, the classical bits, and the qubits with conditional gates, a set of rules or a Clifford equivalent circuit can be used to create the twirled circuits. In the various embodiments herein, twirling can refer to Pauli twirling. Pauli twirling can be defined as an act of inserting single-qubit gates before and after a circuit instruction to convert a noise of the circuit instruction into a Pauli Channel. A Pauli channel can be defined as a quantum channel that can take the form of a sum over Paulis ρ→Σ cᵢPᵢρPᵢ^{†} with Pᵢ, a Pauli operation and cᵢ, a coefficient.

For example, a CNOT gate can display an error associated with the CNOT gate when the CNOT gate is executed on a hardware. Pauli twirling can comprise inserting (e.g., by circuit twirling unit 110) Pauli operations before and after a CNOT gate such that a logical effect of the CNOT gate can be preserved. As such, a Pauli gate can simply be the identity gate, the X gate, the Y gate or the Z gate. Inserting the Pauli operations and averaging over multiple random insertions of Pauli gates can twirl the noise associated with the CNOT gate, wherein a noise channel of the CNOT gate can be reduced to a Pauli channel. A Pauli channel can be a form of noise that can be relatively easier to process, and the Pauli channel can comprise certain favorable properties. Thus, twirling can reduce the noise of the CNOT gate into a form that can be easier to process. Twirling can be performed via various methodologies. For example, twiring can be accomplished by twirling Clifford operations, mid-circuit measurements, etc.

Another aspect of error mitigation and PEC can comprise insertion of dynamical decoupling pulse sequences (or dynamical decoupling sequences) during idle times of qubits to correct phase errors, cross-talks, etc. in the optimized quantum circuit (e.g., the optimized quantum circuit 118). Dynamical decoupling can comprise inserting a sequence of gates (e.g., dynamical decoupling pulse sequence insertion unit 112) that can decouple a system from an environment of the system that can introduce noise into the system. The sequence of dynamical decoupling gates can be provided by system 100 or other entities such as users of system 100. Thus, dynamical decoupling can be described as a form of error suppression. In one or more embodiments, dynamical decoupling pulse sequence insertion unit 112 can insert a dynamical decoupling pulse sequence during an idle duration and a context-switching duration of the optimized quantum circuit (e.g., the optimized quantum circuit 118). In other words, during dynamical decoupling, dynamical decoupling pulse sequence insertion unit 112 can insert dynamical decoupling sequences during both, standard idle times, and context switching idle times of qubits. Dynamical decoupling pulse sequence insertion unit 112 can insert the dynamical decoupling pulse sequence during the idle duration of quantum circuit 118 based on a sequence of dynamical decoupling gates. Within a quantum circuit, there can be multiple context switches and idle durations, however, a single idle duration can only have one dynamical decoupling pulse sequence inserted. In an embodiment, a typical sequence used for dynamical decoupling can involve a pair of X gates. In other embodiments, another entity can be used instead of a pair of X gates.

Yet another aspect of the error mitigation and the PEC can comprise sparse noise model learning, wherein noise generated in a quantum circuit (e.g., in a quantum circuit resulting from insertion of the dynamical decoupling pulse sequences) can be learnt and inverted. In an embodiment, noise learning unit 116 can learn a noise model of the twirled layers of circuit instructions based on a rank deficient Pauli transfer matrix to learn noise generated in the optimized quantum circuit (e.g., optimized quantum circuit 118). More specifically, during noise model learning, noise learning unit 116 can learn a sparse noise model of circuit instructions that can be twirled, by exploiting a non-full rank Pauli Transfer Matrix. The learning of the noise model of the circuit instructions based on the rank deficient Pauli transfer matrix can be performed via a Lasso regularization technique. The Lasso regularization technique can be employed to minimize a strength of a generator that can model noise in one or more circuit instructions.

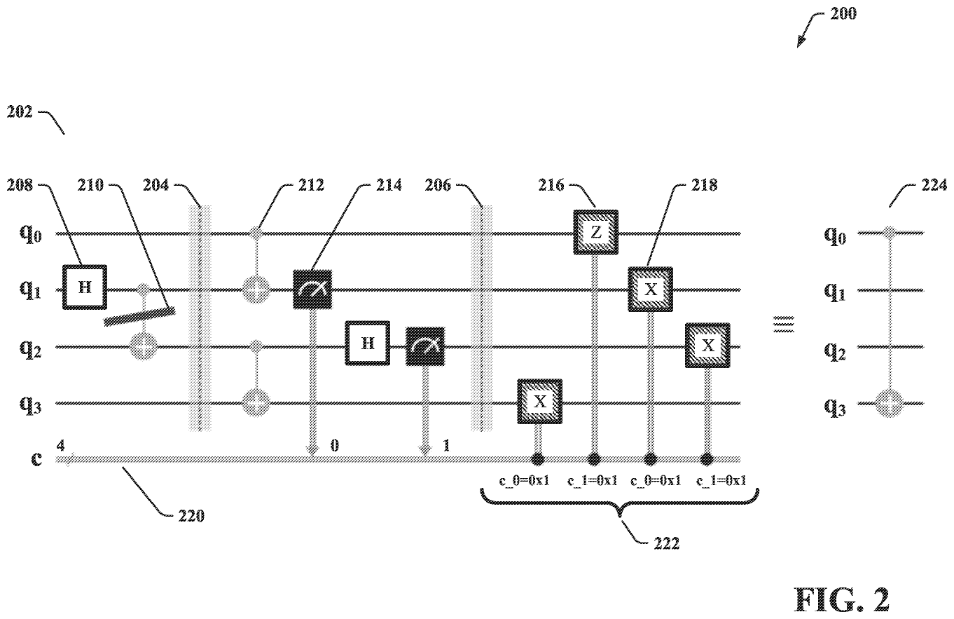

FIG. 2 illustrates a diagram of an example, non-limiting teleportation 200 of a CNOT gate in accordance with one or more embodiments described herein. One or more embodiments described with respect to FIG. 2 can be implemented by one or more components of system 100 of FIG. 1. Repetitive description of like elements and/or processes employed in respective embodiments is omitted for sake of brevity.

FIG. 2 illustrates quantum circuit 202, wherein quantum circuit 202 can be a teleportation circuit for teleportation of a CNOT gate. In FIG. 2, non-limiting teleportation 200 of the CNOT gate can be illustrated by the equivalency (≡) indicating that quantum circuit 224 can be similar to quantum circuit 202. Quantum circuit 202 can comprise qubit 0 (q₀), qubit 1 (q₁), qubit 2 (q₂) and qubit 3 (q₃), Hadamard gates (or H gates), such as the Hadamard gate illustrated at 208, CNOT gates, such as the CNOT gate illustrated at 212, measurement gates, such as the measurement gate illustrated at 214, conditional Z gates (or classically controlled Z gates), such as the Z gate illustrated at 216 and conditional X gates (or classically controlled X gates), such as the X gate illustrated at 218.

It is to be appreciated that in FIGS. 2-24, respective gate types and elements in a quantum circuit have been represented using consistent notations and/or symbols. As such, H gates, conditional X gates and conditional Z gates have respectively been represented by the letters “H,” “X,” and “Z”, CNOT gates have been represented by their unique symbol with the “+” sign and classical communications have been represented by two parallel lines, throughout FIGS. 2-24. It is to be further appreciated that while the X gates and Z gates can respectively be conditional X gates and conditional Z gates (e.g., conditional operations depending on values of classical bits in the classical register), operations not illustrated by two parallel lines can indicated such operations as can occur irrespective of values on the classical register. It is to be appreciated that in FIGS. 2-24, the horizontal lines (solid and/or dashed) respectively correspond to the qubits listed at the left-hand side of a quantum circuit.

Referring now to FIGS. 2-5, aspects of generating virtual gates using LOCC have been described in greater detail.

FIG. 2 further illustrates a classical register c as the double horizontal lines identified at 220. In FIGS. 2, 204 and 206 can illustrate imaginary barriers for visualization. Barriers 204 and 206 can divide quantum circuit 202 into three stages. In quantum circuit 202, stage 1 (left of barrier 204) can illustrate a cut Bell pair, stage 2 (between barriers 204 and 206) can illustrate mid-circuit measurements and stage 3 (right of barrier 206) can illustrate feed-forward operations that the various embodiments discussed herein can aim to mitigate. A mid-circuit measurement can be defined as a measurement of a qubit that is not done at the end of a quantum circuit.

As described above, quantum circuit 202 can be a teleportation circuit that can teleport a CNOT gate. For example, quantum circuit 202 can enable a virtual gate between q₀ and q₃ to teleport the CNOT gate. The virtual gate can be created by engineering an effect of the CNOT gate between q₀ and q₃ without q₀ and q₃ being connected to one another. Engineering the effect of the CNOT gate between q₀ and q₃ without applying a quantum gate between q₀ and q₃ can be achieved via LOCC. As stated elsewhere herein, LOCC refers to local operations and classical communication. LOCC can be defined as a quantum computing architecture capable of executing virtual gates built from local operations (e.g., single-qubit gates and measurements) and classical communication (e.g., a quantum gate classically controlled by the outcome of a measurement done on a qubit). With respect to quantum circuit 202, this can imply that operations respective to q₀ and q₃ can be local operations (e.g., performed by local quantum gates) and communication between q₀ and q₃ can be classical communication. In an embodiment, the local operations can refer to operations local to respective QPUs. In another embodiment, the local operations can refer to operations local to respective locations within a single QPU. As such, LOCC can allow for execution of virtual gates between QPUs or between different locations within a single QPU.

As illustrated in quantum circuit 202, the measurement gates can output measurements into the classical register c and based on a value of classical bits in the register, an X gate or a Z gate can be applied on qubits q₀, q₁, q₂ or q₃, as illustrated in stage 3 (right of barrier 206) of quantum circuit 202. In stage 3 of quantum circuit 202, the notations on the classical register can indicate a conditional for a gate. For example, as identified at 222, an X gate can be applied on q₃ if a classical bit zero (0) in the classical register has value 1 (c_0=0x1), a Z gate can be applied to q₀ if a classical bit 1 has value 1 (c_1=0x1), an X gate can be applied to q₁ if the classical bit 0 in the classical register has value 1 (c_0=0x1), and an X gate can be applied to q₂ if the classical bit 1 in the classical register has value 1 (c_1=0x1).

Quantum circuit 202 can utilize a Bell pair for teleporting a CNOT gate, wherein quantum circuit 202 can turn the Bell pair into the CNOT gate for teleporting the CNOT gate. A Hadamard gate followed by a CNOT gate can correspond to a Bell pair. The cut Bell pair that can be utilized by quantum circuit 202 is illustrated in stage 1 (i.e., to the left of barrier 204) of quantum circuit 202. The Bell pair can be created between q₁ and q₂, and followed by execution of stage 2 and stage 3 (i.e., to the right of barrier 204) of quantum circuit 202, the Bell pair can result in an overall effect of creating the CNOT gate between q₀ and q₃, as illustrated by quantum circuit 224. Stated differently, the cut Bell pair can be consumed to teleport the CNOT gate.

The Bell pair in stage 1 of quantum circuit 202 can be a cut Bell pair that can cut quantum circuit 202. Line 210 (e.g., shown as cutting the CNOT gate of the Bell pair) can represent the cutting of quantum circuit 202 by the cut Bell pair. Cut bell pairs can be defined as bell pairs that can be implemented with a quasi-probability decomposition, which can allow the Bell pairs to be split between quantum circuits that only communicate classically. For example, for teleporting the CNOT gate, the CNOT can be decomposed into local operations, which can allow quantum circuit 202 to be cut into two portions, resulting in a first portion between q₀ and q₁ and a second portion between q₂ and q₃. The resulting first portion and second portion of quantum circuit 202 can only remain connected by classical communication, as indicated by the double vertical lines emerging from the measurement gates, the conditional X gates and the conditional Z gates, and travelling towards the classical register. That is, upon cutting on quantum circuit 202, q₁ and q₂ can only remain connected by the Bell pair in stage 1 of quantum circuit 202 without being connected by any other gate. The Bell pair can be implemented by a quasi-probability decomposition. Quasi-probability decomposition can be defined as a decomposition of a quantum channel ε as a sum over other quantum channels ε(ρ)=Σᵢa₁εᵢ(ρ). The coefficients aᵢ in the sum can form a quasi-probability distribution and can be converted to a proper probability distribution

$$ℰ ( ρ ) = γ {\sum }_{i} \frac{\vert {a}_{i} \vert}{γ} sign ( {a}_{i} ) {ℰ}_{i} ( ρ )$$

at the cost of a sampling overhead. Herein, γ=Σ|aᵢ| can measure the sampling overhead γ².

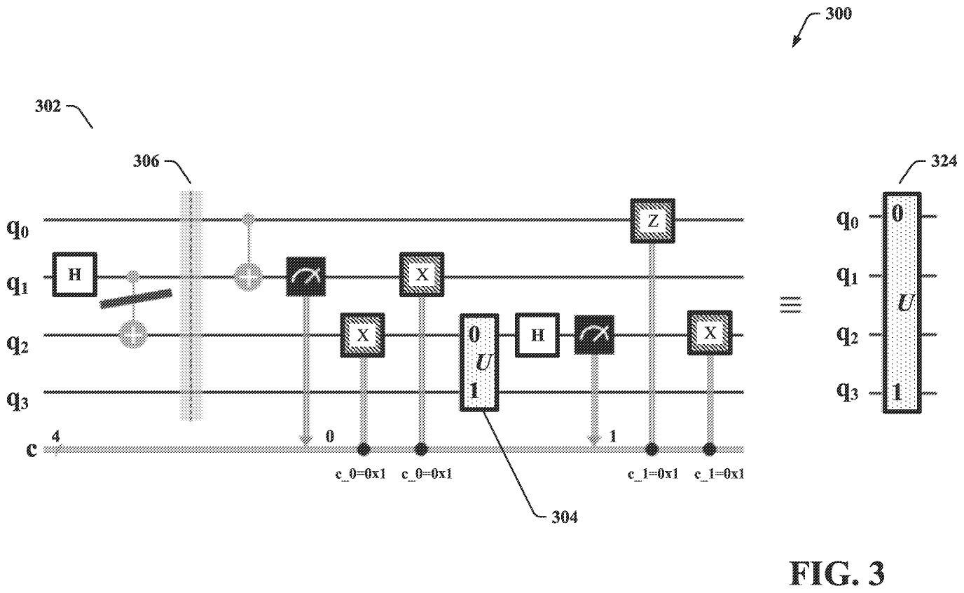

FIG. 3 illustrates a diagram of an example, non-limiting teleportation 300 of a controlled single-qubit rotation in accordance with one or more embodiments described herein. One or more embodiments described with respect to FIG. 3 can be implemented by one or more components of system 100 of FIG. 1. Repetitive description of like elements and/or processes employed in respective embodiments is omitted for sake of brevity.

FIG. 3 further illustrates quantum circuit 302, wherein quantum circuit 302 can be a teleportation circuit for teleportation of unitary 304, wherein unitary 304 can represent a controlled single-qubit rotation. For example, unitary 304 can be an Rₓₓ gate, an R_{yy} gate, a controlled single-qubit gate such as a C_{z} gate or a C_{y} gate, etc. In FIG. 3, non-limiting teleportation 300 of the controlled single-qubit rotation can be illustrated by the equivalency (≡) indicating that quantum circuit 324 can be identical to quantum circuit 302. Quantum circuit 302 can comprise qubits q₀, q₁, q₂ and q₃, Hadamard gates (or H gates), CNOT gates, measurement gates, conditional Z gates and conditional X gates. FIG. 3 further illustrates a classical register c as double horizontal lines emerging towards the right-hand side of FIG. 3.

In FIG. 3, 306 can illustrate an imaginary barrier for visualization. Barrier 306 can divide quantum circuit 302 into two stages. In quantum circuit 302, stage 1 (i.e., to the left of barrier 306) can illustrate a cut Bell pair that can be consumed for teleportation of unitary 304. In stage 2 of quantum circuit 302, the notations on the classical register can indicate respective conditionals (e.g., (c_0=0x1) or (c_0=0x1)) for the X gates or the Z gate. Consumption of the cut Bell pair illustrated in stage 1 of quantum circuit 302 followed by operations illustrated in stage 2 of quantum circuit 302 can result in unitary 304 being teleported between teleported between q₀ and q₃, as illustrated in quantum circuit 324.

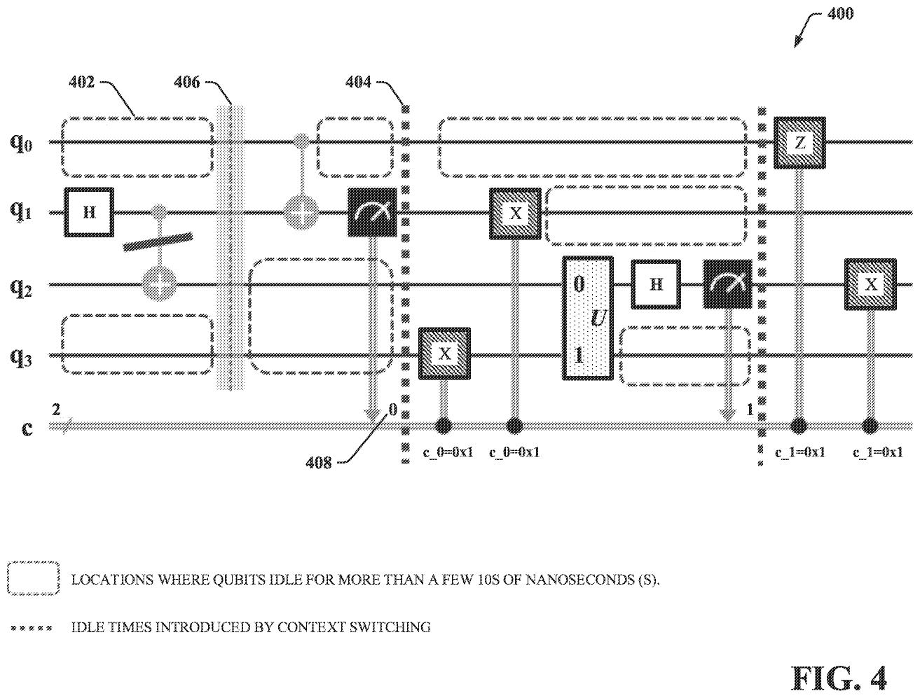

FIG. 4 illustrates a diagram of an example, non-limiting quantum circuit 400 for teleportation of a controlled single-qubit rotation and idle times of qubits in accordance with one or more embodiments described herein. One or more embodiments described with respect to FIG. 4 can be implemented by one or more components of system 100 of FIG. 1. Repetitive description of like elements and/or processes employed in respective embodiments is omitted for sake of brevity.

Non-limiting quantum circuit 400 (hereinafter, quantum circuit 400) can be a teleportation circuit for teleportation of a unitary (e.g., unitary 304 of FIG. 4), wherein the unitary can represent a controlled single-qubit rotation. For example, unitary 304 can be an Rₓₓ gate, an R_{yy} gate, a controlled single-qubit gate such as a C_{z} gate or a C_{y} gate, etc. Quantum circuit 400 can be identical to quantum circuit 302, and quantum circuit 400 can comprise qubits q₀, q₁, q₂ and q₃, Hadamard gates (or H gates), CNOT gates, measurement gates, conditional Z gates and conditional X gates. FIG. 4 further illustrates a classical register c as double horizontal lines emerging towards the right-hand side of FIG. 4. In FIG. 4, 406 can illustrate an imaginary barrier for visualization. Barrier 406 can divide quantum circuit 400 into two stages. In quantum circuit 400, stage 1 (i.e., to the left of barrier 406) can illustrate a cut Bell pair that can be consumed for teleportation of the unitary. In stage 2 of quantum circuit 400, the notations on the classical register can indicate respective conditionals (e.g., (c_0=0x1) or (c_0=0x1)) for the conditional X gates or the conditional Z gate.

In FIG. 4, the dashed rectangles, such as the dashed rectangle illustrated at 402, can represent locations where qubits can be idle for more than a few 10 s of nanoseconds (ns). The locations identified by the dashed rectangles on quantum circuit 400 can indicate points in time when qubits can be idle (i.e., not performing any action) or when some qubits can be idle while some other qubits can be involved in an operation. For example, at 402, no gate is illustrated as being applied to q₀, indicating a point in time when q₀ can be idling. However, at that same point in time, q₁ can be involved in operations involving the creation of a cut Bell pair by quantum circuit 400, as illustrated in stage 1 of quantum circuit 400. Such idle times can lead to accumulation of errors in quantum circuit 400. It is to be appreciated that consumption of the cut Bell pair can occur after stage 1.

Further, the vertical dashed lines, can represent idle times introduced by context switching, such as illustrated by context switch 404. That is, the dashed lines can indicate context switches, wherein based on a measurement taken by a measurement gate, one or more operations that can follow the measurement can be decided. For example, as stated elsewhere herein, the measurement gates can output measurements into the classical register c and based on a value of classical bits in the register, an X gate or a Z gate can be applied on qubits q₀, q₁, q₂ or q₃. For example, based on the first measurement of 0 illustrated at 408 in quantum circuit 400, the two conditional X gates (i.e., conditional X gates to the right of the context switch 404) can be decided, such that the two conditional X gates can be applied if a classical bit 0 on the classical register has a value of 1 (c_0=0x1). The process of deciding on the type of operation that can follow a measurement can be time consuming. For example, although not illustrated in quantum circuit 400, context switch 404 can indicate some idle time between the measurement taken by the measurement gate to the left of context switch 404 and the controlled operation represented by the conditional X gate to the right of the context switch 404. It is to be appreciated that while the conditional X gates and the conditional Z gates can respectively represent operations that can depend on values of classical bits in the classical register, operations not illustrated by two parallel lines can indicated such operations as can occur irrespective of values on the classical register.

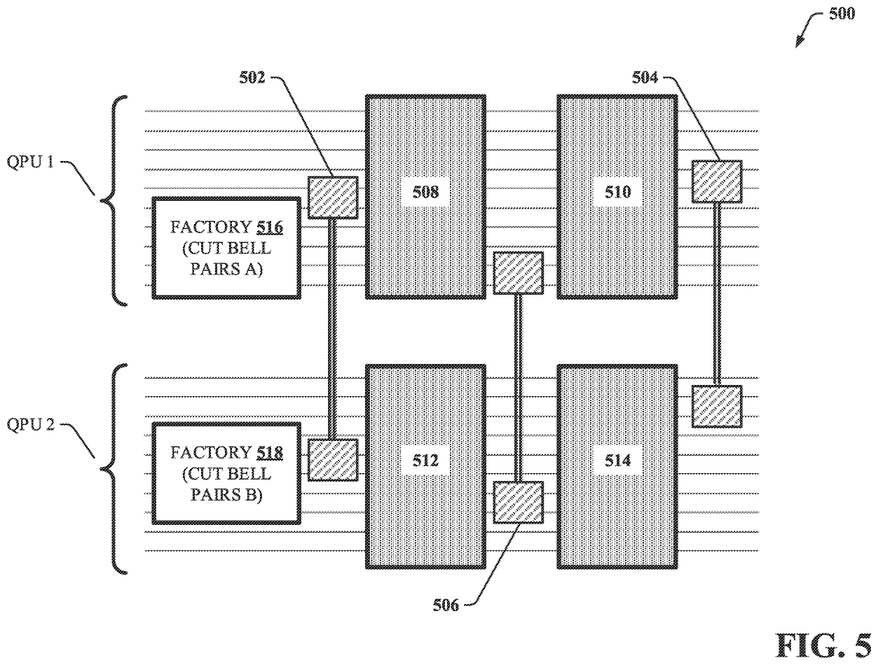

FIG. 5 illustrates a diagram of an example, non-limiting representation 500 of cut Bell pairs and consumption of the cut Bell pairs in accordance with one or more embodiments described herein. One or more embodiments described with respect to FIG. 5 can be implemented by one or more components of system 100 of FIG. 1. Repetitive description of like elements and/or processes employed in respective embodiments is omitted for sake of brevity.

FIG. 5 illustrates virtual gates implemented between QPU 1 and QPU 2 via LOCC, wherein 502, 504 and 506 can represent virtual two-qubit gates with LOCC, 508, 510, 512 and 514 can represent a non-cut portion of an algorithm implemented to generate the virtual gates, and factory 516 and factory 518 can represent Bell pair factories (or cut Bell pair factories) that can be a location on a quantum circuit where cut Bell pairs can be produced. Stated differently, a Bell pair factory can represent a set of instructions that can create cut Bell pairs. The non-cut portions of the algorithm (e.g., 508, 510, 512 and 514) can include cut Bell pair routing. To implement LOCC operations for executing virtual gates, multiple cut Bell pairs can be needed to be generated at the same time by factory 516 and factory 518, for example, as opposed to a single cut Bell pair comprising a Hadamard gate followed by a CNOT gate. For example, in practice, multiple Bell pairs can be simultaneously generated and cut.

The Bell pairs can be generated in a Bell pair factory such as, for example, factory 516 and factory 518. Thereafter, the Bell pairs can be consumed to implement the virtual two-qubit gates (e.g., 502, 504 and 506). For example, as illustrated in non-limiting representation 500 of FIG. 5, three Bell pairs can be generated and consumed through a quantum circuit to generate virtual two-qubit gates 502, 504 and 506 between QPU 1 and QPU 2. A quantum circuit associated with QPU1 and QPU2 can execute non-cut portions of an algorithm (e.g., 508, 510, 512 and 514) when the virtual two-qubit gates are not being executed, as illustrated. With reference to FIG. 2, qubits q₀ and q₁ can correspond to operations being performed on QPU 1 of FIG. 5, and qubits q₂ and q₃ can correspond to operations being performed on QPU 2 of FIG. 5. With further reference to FIG. 2, stage 2 and stage 3 of quantum circuit 202 can represent operations that can be performed to implement the virtual two-qubit gates (e.g., 502, 504 and 506) of FIG. 5. Thus, each instance of a virtual two-qubit gate (e.g., 502, 504 or 506) in FIG. 5 can represent the quantum circuit 202 being executed wherein a cut Bell pair (e.g., such as the cut Bell pair illustrated in stage 1 of quantum circuit 202) is being consumed.

Since several cut Bell pairs can be generated simultaneously in a factory (e.g., factory 516, factory 518), and since the cut Bell pairs can only be consumed according to an order of execution specified in the algorithm, there can be a time delay between production of the cut Bell pairs and consumption of the cut Bell pairs. That is, several Bell pairs can idle until their consumption, and the time delay can lead to errors that can build up on the cut Bell pairs. The states of cut Bell pairs that can idle can be stabilized and error mitigated, for example, with PEC.

Generating error mitigated networks of conditional gates in larger quantum circuits for creating virtual gates via LOCC can comprise circuit optimization (e.g., by circuit transpiler unit 108) wherein networks of conditional gates can be identified, and mid-circuit measurements that can be executed in parallel, can be placed in parallel. More specifically, circuit optimization can comprise identifying networks of conditional gates and performing as many mid-circuit measurements in parallel as possible because mid-circuit measurements can be very time consuming. Upon reorganizing a quantum circuit (e.g., quantum circuit 202, quantum circuit 302, quantum circuit 400), error mitigation can be implemented into the quantum circuit via PEC. Further, a transpiler (e.g., circuit transpiler unit 108) can elect to convert a conditional basis to a hardware-friendly representation. For example, the transpiler can convert a conditional X gate to a conditional Z gate and vice-versa.

Operations for performing PEC can involve twirling of the mid-circuit measurements and classical conditionals (e.g., by circuit twirling unit 110), wherein the twirling can be performed using a set of twirling rules or extra logic. Further, twirling circuits can be determined based on knowledge of a relationship between measured qubits, classical bits, and qubits with conditional gates. For example, based on the relationship between the measured qubits, the classical bits, and the qubits with conditional gates, a set of rules or a Clifford equivalent circuit can be used to create the twirled circuits. In the various embodiments herein, twirling can refer to Pauli twirling. Pauli twirling can be defined as an act of inserting single-qubit gates before and after a circuit instruction to convert a noise of the circuit instruction into a Pauli Channel. A Pauli channel can be defined as a quantum channel that can take the form of a sum over Paulis ρ→ΣcᵢPᵢρPᵢ^{†} with Pᵢ, a Pauli operation and cᵢ, a coefficient.

For example, a CNOT gate can display an error associated with the CNOT gate when the CNOT gate is executed on a hardware. Pauli twirling can comprise inserting Pauli operations before and after a CNOT gate such that a logical effect of the CNOT gate can be preserved. As such, a Pauli gate can simply be the identity gate, the X gate, the Y gate or the Z gate. Inserting the Pauli operations and averaging over multiple random insertions of Pauli gates can twirl the noise associated with the CNOT gate, wherein a noise channel of the CNOT gate can be reduced to a Pauli channel. A Pauli channel can be a form of noise that can be relatively easier to process, and the Pauli channel can comprise certain favorable properties. Thus, twirling can reduce the noise of the CNOT gate into a form that can be easier to process. Twirling can be performed via various methodologies. For example, twiring can be accomplished by twirling Clifford operations, mid-circuit measurements, etc.

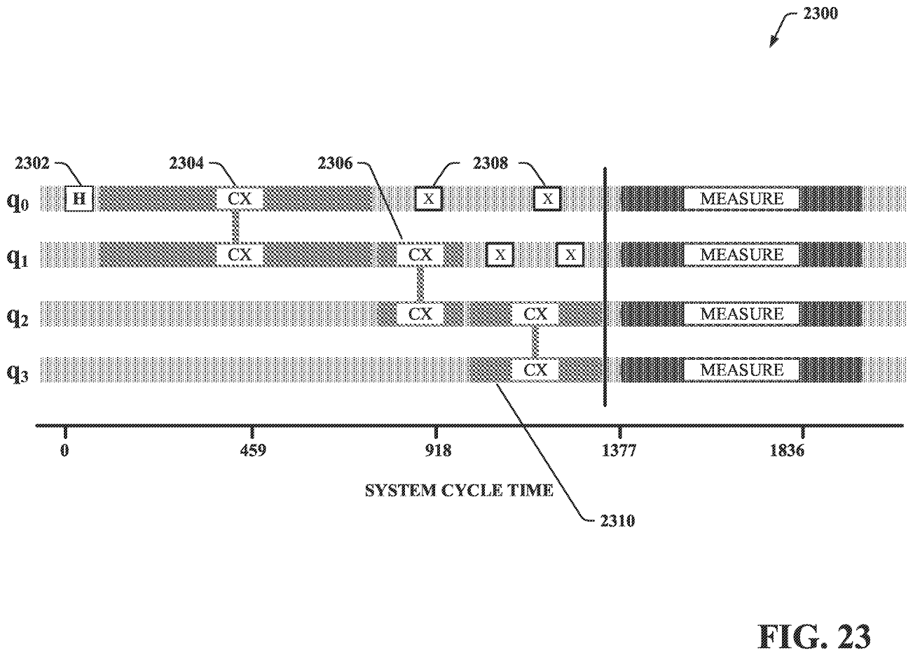

Another aspect of error mitigation and PEC can comprise insertion of dynamical decoupling pulse sequences (or dynamical decoupling sequences) during idle times of qubits to correct phase errors, cross-talks, etc. Dynamical decoupling can comprise inserting a sequence of gates (e.g., dynamical decoupling pulse sequence insertion unit 112) that can decouple a system from an environment of the system that can introduce noise into the system. Thus, dynamical decoupling can be described as a form of error suppression. During dynamical decoupling, dynamical decoupling sequences can be inserted during both, standard idle times, and context switching idle times of qubits (e.g., as illustrated in FIG. 4). Within a quantum circuit, there can be multiple context switches and idle durations, however, a single idle duration can only have one dynamical decoupling pulse sequence inserted. A typical sequence used for dynamical decoupling can involve a pair of X gates, which has been illustrated in FIG. 23. In some embodiments, another entity can be used instead of a pair of X gates.

Yet another aspect of the error mitigation and the PEC can comprise sparse noise model learning, wherein noise generated in a quantum circuit (e.g., in a quantum circuit resulting from insertion of the dynamical decoupling pulse sequences) can be learnt and inverted. During noise model learning, a sparse noise model of circuit instructions that can be twirled can be learnt (e.g., by noise learning unit 116) by exploiting a non-full rank Pauli Transfer Matrix. As stated elsewhere herein, the error mitigated networks of conditional gates can be used in virtual gates implemented via LOCC.

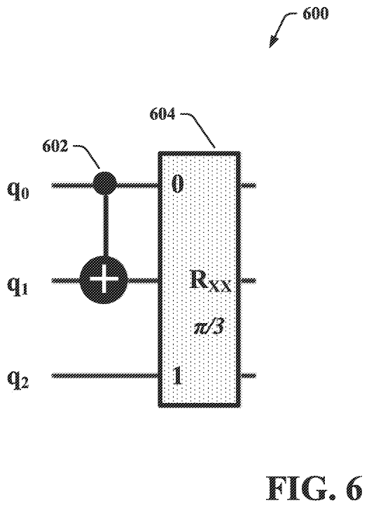

Referring now to FIGS. 6-11, the circuit optimization aspect of generating the error mitigated networks of conditional gates has been described in greater detail.

FIG. 6 illustrates a diagram of an example, non-limiting quantum circuit 600 comprising gates that can be teleported in accordance with one or more embodiments described herein. One or more embodiments described with respect to FIG. 6 can be implemented by one or more components of system 100 of FIG. 1. Repetitive description of like elements and/or processes employed in respective embodiments is omitted for sake of brevity.

In one or more embodiments, generating error mitigated networks of conditional gates in larger quantum circuits for creating virtual gates via LOCC can comprise circuit optimization (e.g., circuit transpiler unit 108) wherein networks of conditional gates can be identified, and mid-circuit measurements that can be executed in parallel, can be placed in parallel. LOCC can be advantageous towards implementing virtual gates when multiple gates can be cut, and execution of a quantum circuit can feature more than one virtual gate (e.g., virtual LOCC gate). However, conditional gates can be time consuming due to context switching, and placing mid-circuit measurements in parallel can minimize a context switching time. Multiple optimizations can be performed. Further, a transpiler (e.g., circuit transpiler unit 108) can elect to convert a conditional basis to a hardware-friendly representation. For example, the transpiler can convert a conditional X gate to a conditional Z gate and vice-versa.

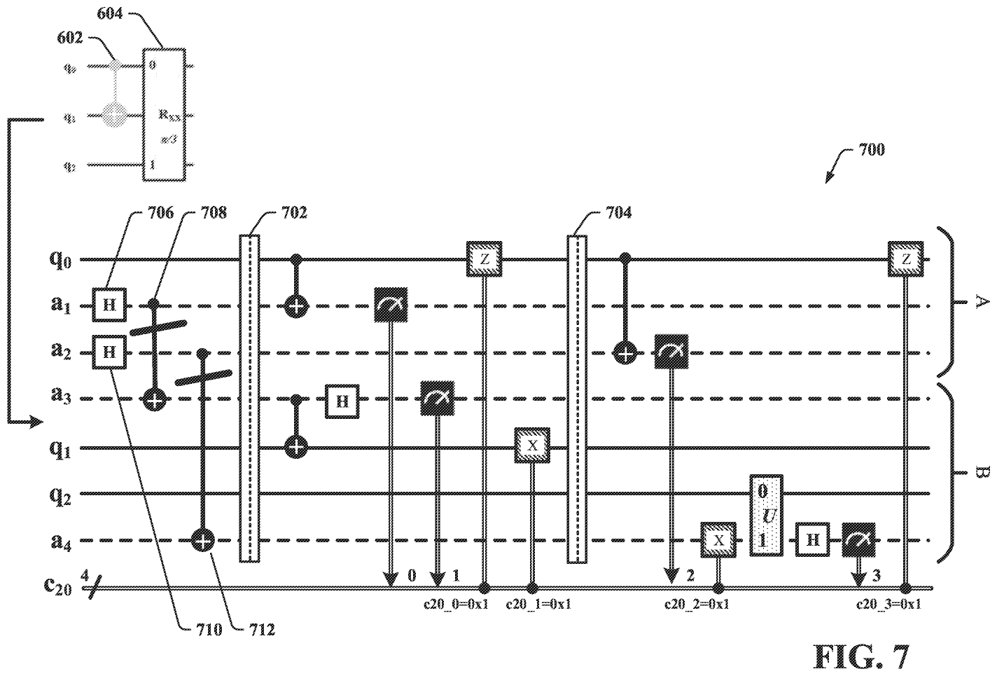

In one or more embodiments, mid-circuit measurements of different virtual CNOT gates can be performed in parallel where possible to minimize a context switching time. Non-limiting quantum circuit 600 (hereinafter, quantum circuit 600) can be a simple quantum circuit comprising qubits q₀, q₁ and q₂, CNOT gate 602 between qubits q₀ and q₁, and Rₓₓ gate 604 between qubit q₀ and q₂. Quantum circuit 600 can be cut to teleport CNOT gate 602 and Rₓₓ gate 604, for example, by separating q₀ from q₁ and q₂. Quantum circuit 600 can be cut by implementing cut Bell pairs, as illustrated in FIGS. 2 and 3, which can result in quantum circuit 700 illustrated in FIGS. 7-9.

FIG. 7 illustrates a diagram of an example, non-limiting quantum circuit 700 that can be optimized for teleportation of quantum gates in accordance with one or more embodiments described herein. One or more embodiments described with respect to FIG. 7 can be implemented by one or more components of system 100 of FIG. 1. Repetitive description of like elements and/or processes employed in respective embodiments is omitted for sake of brevity.

As discussed above, generating error mitigated networks of conditional gates in larger quantum circuits for creating virtual gates via LOCC can comprise circuit optimization (e.g., by circuit transpiler unit 108) wherein networks of conditional gates can be identified, and mid-circuit measurements that can be executed in parallel, can be placed in parallel. LOCC can be advantageous towards implementing virtual gates when multiple gates can be cut, and execution of a quantum circuit can feature more than one virtual gate (e.g., virtual LOCC gate). However, conditional gates can be time consuming due to context switching, and placing mid-circuit measurements in parallel can minimize a context switching time. Multiple optimizations can be performed. Further, a transpiler (e.g., circuit transpiler unit 108) can elect to convert a conditional basis to a hardware-friendly representation. For example, the transpiler can convert a conditional X gate to a conditional Z gate and vice-versa.

With continued reference to FIG. 6, quantum circuit 700 can comprise qubits q₀, q₁, and q₂, ancilla qubits a₁, a₂, a₃ and a₄, Hadamard gates (or H gates), CNOT gates, measurement gates, conditional Z gates, conditional X gates and a unitary (e.g., unitary 304). It is to be appreciated that the solid and dashed horizontal lines in quantum circuit 700 respectively correspond to the qubits listed to the left of the lines. FIG. 7 further illustrates a classical register c₂₀ as double horizontal lines emerging at c₂₀ and travelling towards the right-hand side of FIG. 7. In FIGS. 7, 702 and 704 can illustrate imaginary barriers for visualization. Barriers 702 and 704 can divide non-limiting quantum circuit 700 (or quantum circuit 700) into three stages, wherein stage 1 (i.e., to the left of barrier 702) can comprise cut Bell pairs, stage 2 (i.e., between barriers 702 and 704) can correspond to a portion of quantum circuit 700 for implementing a virtual CNOT gate, and stage 3 (i.e., to the right of barrier 704) can correspond to a portion of quantum circuit 700 for implementing the unitary. For example, quantum circuit 700 can be a teleportation circuit resulting from implementing cut Bell pairs to teleport CNOT gate 602 and Rₓₓ gate 604 from FIG. 6. As such, quantum circuit 700 can be similar to quantum circuit 600, wherein stage 2 of quantum circuit 700 can implement a virtual CNOT gate equivalent to CNOT gate 602 and stage 3 of quantum circuit 700 can implement a virtual Rₓₓ gate equivalent to Rₓₓ gate 604. It is to be appreciated that FIG. 7 illustrates a representation of a quantum circuit as opposed to an implementation of how the quantum circuit can be run on a hardware.

In quantum circuit 700, stage 1 can illustrate two cut Bell pairs, wherein CNOT gates can be cut, and the cut Bell pairs can be implemented with a quasi-probability decomposition. In stage 1, the cut Bell pair comprising the Hadamard gate illustrated at 706 and the CNOT gate illustrated at 708 can be implemented for teleporting CNOT gate 602, whereas the cut Bell pair comprising the Hadamard gate illustrated at 710 and the CNOT gate illustrated at 712 can be implemented for teleporting Rₓₓ gate 604. Stage 2 in quantum circuit 700 comprising two CNOT gates, a Hadamard gate, two mid-circuit measurements and the conditional Z and X operations can correspond to the virtual CNOT gate for CNOT gate 602 in quantum circuit 600. In stage 2, the conditional Z gate can be applied to q₀ if the classical bit 0 on the classical register has a value of 1 (c20_0=0x1), whereas the conditional X gate can be applied to q₁ if the classical bit 1 on the classical register has a value of 1 (c20_1=0x1). Similarly, stage 3 in quantum circuit 700 comprising the CNOT gate, a mid-circuit measurement, the unitary, the Hadamard gate and the conditional Z and X operations can correspond to the virtual Rₓₓ gate for Rₓₓ gate 604 of quantum circuit 600. In stage 3, the conditional X gate can be applied to a₄ if the classical bit 2 on the classical register has a value of 1 (c20_2=0x1), whereas the conditional Z gate can be applied to q₀ if the classical bit 3 on the classical register has a value of 1 (c20_3=0x1).

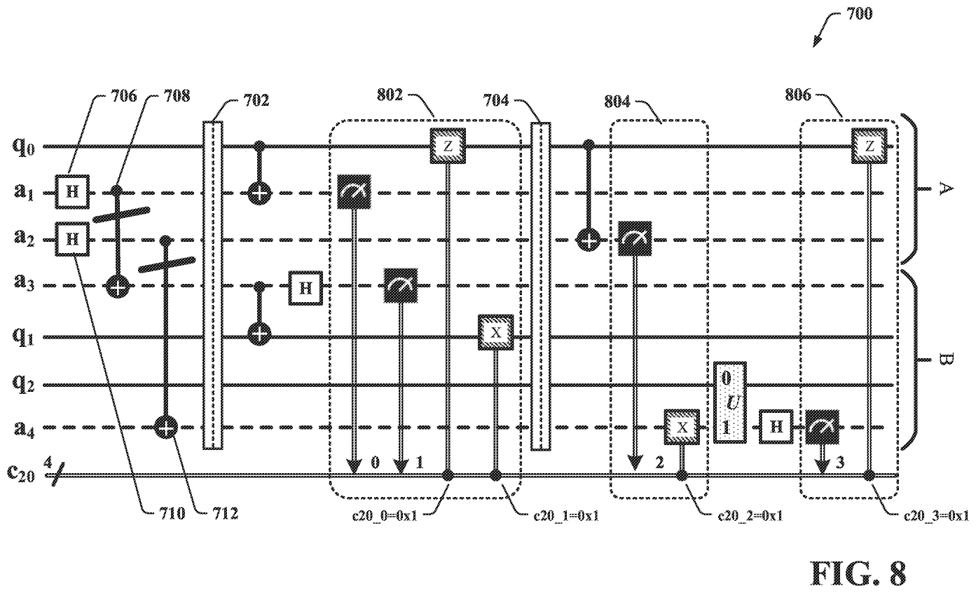

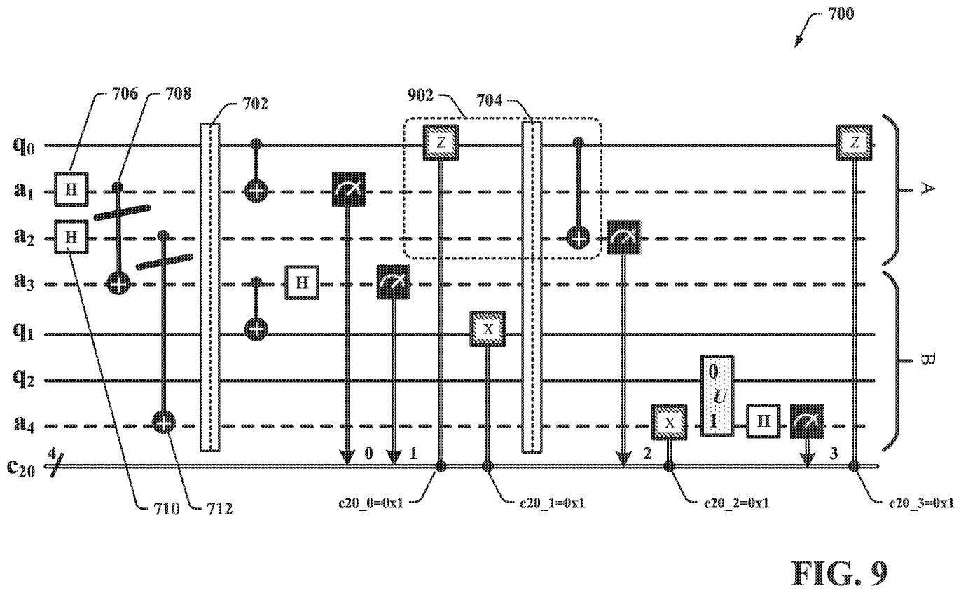

Considering sub-portion A and sub-portion B of quantum circuit 700, wherein sub-portion A can correspond to qubits q₀, a₁ and a₂, and sub-portion B can correspond to qubits a₃, q₁, q₂ and a₄, there can be no quantum communications between the sub-portions. That is, sub-portion A and sub-portion B of quantum circuit 700 can only communicate via classical communication due to implementation of the cut Bell pairs with a quasi-probability decomposition in stage 1 of quantum circuit 700. The transpilation steps involved in optimizing quantum circuit 700 can be described in greater detail with reference to FIGS. 8-9.

FIG. 8 illustrates a diagram of the example, non-limiting quantum circuit 700 of FIG. 7 identifying consecutive measurement blocks in quantum circuit 700 in accordance with one or more embodiments described herein. One or more embodiments described with respect to FIG. 8 can be implemented by one or more components of system 100 of FIG. 1. Repetitive description of like elements and/or processes employed in respective embodiments is omitted for sake of brevity.

In FIG. 8, block 802, block 804 and block 806 can represent three consecutive measurement blocks or three groups of mid-circuit measurements in quantum circuit 700. Blocks 802-806 can further highlight a poor circuit compilation of quantum circuit 700 because, as discussed in one or more embodiments, conditional operations can be decided based on preceding measurements, and a process of deciding on a type of operation that can follow a measurement can be time consuming. In an embodiment, quantum circuit 700 can be optimized to generate error mitigated networks of conditional gates by commuting the conditional Z gate (or classically conditioned Z gate) from stage 2 (i.e., between barriers 702 and 704) of quantum circuit 700 and the CNOT gate from stage 3 (i.e., to the right of barrier 704) of quantum circuit 700. That is, quantum circuit 700 can be optimized by moving the CNOT gate forward towards the left-hand side of quantum circuit 700.

FIG. 9 illustrates another diagram of the example, non-limiting quantum circuit 700 of FIG. 7 identifying a classically controlled Z gate and a CNOT gate in quantum circuit 700 in accordance with one or more embodiments described herein. One or more embodiments described with respect to FIG. 9 can be implemented by one or more components of system 100 of FIG. 1. Repetitive description of like elements and/or processes employed in respective embodiments is omitted for sake of brevity.

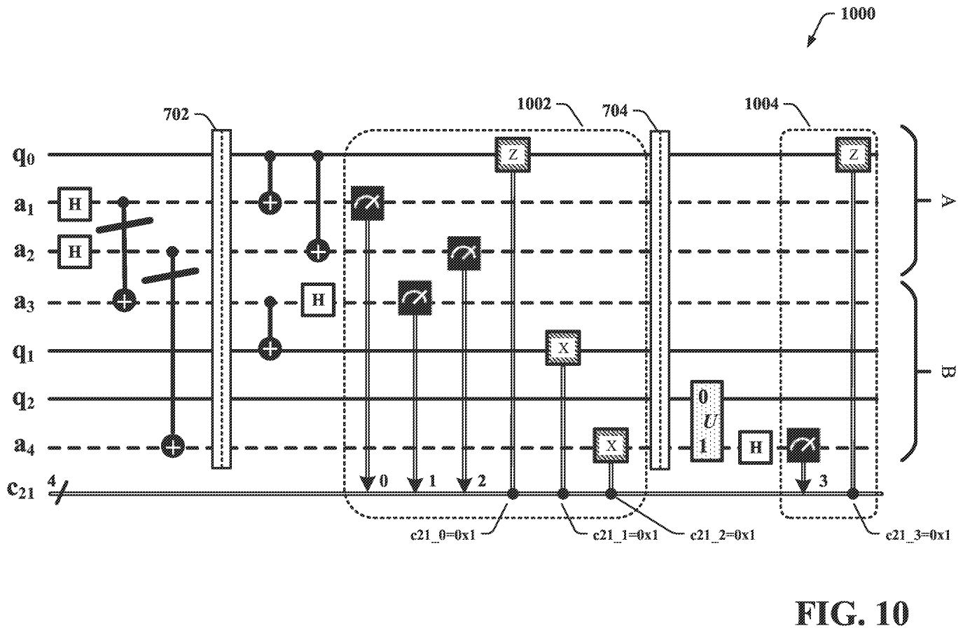

In FIG. 9, block 902 can identify the conditional Z gate (or classically conditioned Z gate) and the CNOT gate in quantum circuit 700 that can be commuted to optimized quantum circuit 700 such that more mid-circuit measurements can be performed in parallel. For example, an order of execution of the conditional Z gate from stage 2 (i.e., between barriers 702 and 704) of quantum circuit 700 and an order of execution of the CNOT gate from stage 3 (i.e., to the right of barrier 704) of quantum circuit 700 can be flipped, resulting in non-limiting quantum circuit 1000 of FIG. 10.

FIG. 10 illustrates a diagram of an example, non-limiting quantum circuit 1000 identifying a classically controlled Z gate commuted past a CNOT gate in accordance with one or more embodiments described herein. One or more embodiments described with respect to FIG. 10 can be implemented by one or more components of system 100 of FIG. 1. Repetitive description of like elements and/or processes employed in respective embodiments is omitted for sake of brevity.

With continued reference to FIGS. 6-9, non-limiting quantum circuit 1000 (hereinafter, quantum circuit 1000) can result from commuting (e.g., by circuit transpiler unit 108) the conditional Z gate (or classically controlled Z gate) from stage 2 (i.e., between barriers 702 and 704) of quantum circuit 700 past the CNOT gate from stage 3 (i.e., to the right of barrier 704) of quantum circuit 700. As described elsewhere herein, context switching can refer to a phenomenon wherein based on a measurement taken by a measurement gate, one or more operations that can follow the measurement can be decided, and the process of deciding the type of operations can be time consuming. Thus, commuting the conditional Z gate from stage 2 past the CNOT gate from stage 3 of quantum circuit 700 can reduce an amount of context switching instances from three instances to two instances. For example, quantum circuit 700 can comprise three instances of context switches due to three separate instances of mid-circuit measurements, as identified by blocks 802, 804 and 806 in FIG. 8. However, quantum circuit 1000 can comprise two instances of context switches due to there being two separate instances of mid-circuit measurements, as identified by block 1002 and block 1004.

Stated differently, quantum circuit 1000 can illustrate the CNOT gate from stage 3 of quantum circuit 700 commuted past the conditional Z gate, which can allow block 802 and block 804 of quantum circuit 700 illustrated in FIG. 8 to be merged. This can result in two blocks of mid-circuit measurements with three mid-circuit measurements that can be executed in parallel, as illustrated in block 1002 and another mid-circuit measurement that can be executed individually, as illustrated in block 1004. Herein, commuting can refer to performing operations in a different order such as, for example, applying the CNOT gate before the conditional Z gate after commuting the conditional Z gate past the CNOT gate. Commuting operations can have some advantages. For example, as discussed above, switching the order of the conditional Z gate and the CNOT gate can allow the mid-circuit measurement from stage 3 of quantum circuit 700 to be merged with the mid-circuit measurements from stage 2 of quantum circuit 700, thereby reducing the amount of context switches.

As stated elsewhere herein, the conditionals (e.g., (c21_0=0x1), (c21_1=0x1), (c21_2=0x1) and (c21_3=0x1)) can indicate values of classical bits upon which the single-qubit quantum gates (e.g., conditional X and conditional Z gates can depend on). Since context switches can indicate idle times in a quantum circuit, optimizing a quantum circuit as described in various embodiments herein can lead to a gain of 1.5 microseconds (s) on some hardware. In an embodiment, qubits q₀, a₁ and a₂ can be on a first QPU and qubits a₃, q₁, q₂ and a₄ can be on a second QPU such that the first QPU and the second QPU can communicate via classical communication. In another embodiment, qubits q₀, a₁ and a₂ can be at a first location within a QPU and qubits a₃, q₁, q₂ and a₄ can be at a second location within the same QPU such that sub-portion A of quantum circuit 1000 comprising qubits q₀, a₁ and a₂ and sub-portion B of quantum circuit 1000 comprising qubits a₃, q₁, q₂ and a₄ cannot be connected by any quantum gates.

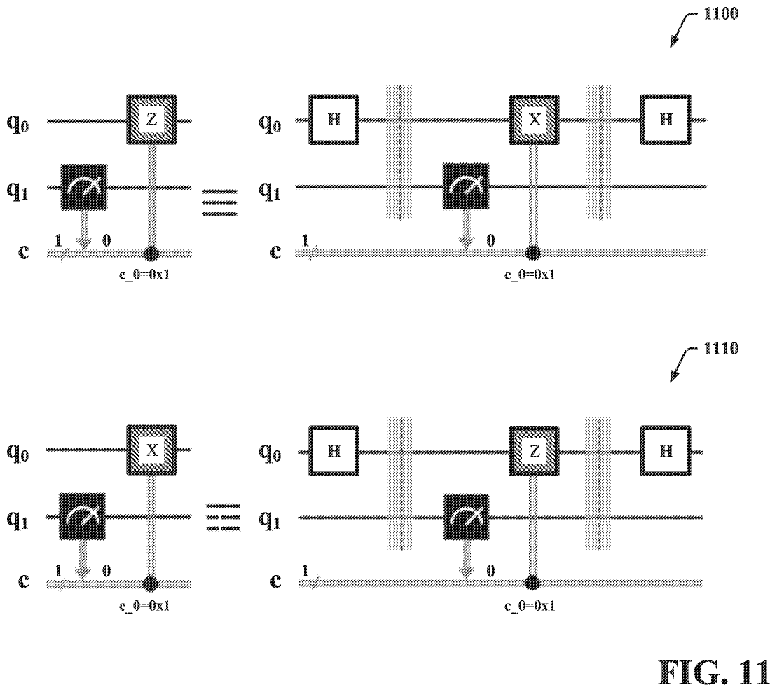

FIG. 11 illustrates diagrams of example, non-limiting conversions 1100 and 1110 of conditional X and Z gates using Hadamard gates in accordance with one or more embodiments described herein. One or more embodiments described with respect to FIG. 11 can be implemented by one or more components of system 100 of FIG. 1. Repetitive description of like elements and/or processes employed in respective embodiments is omitted for sake of brevity.

As stated elsewhere herein, circuit transpiler unit 108 can adapt a plurality of quantum gates and one or more classically controlled instructions in a quantum circuit to a hardware that can execute the plurality of quantum gates and the one or more classically controlled instructions. Adapting the plurality of quantum gates to the hardware can comprise converting a classically controlled Z gate to a classically controlled X gate or converting the classically controlled X gate to the classically controlled Z gate. With continued reference to FIGS. 7-10, since a teleportation circuit, such as quantum circuit 700 and quantum circuit 1000 can utilize only conditional X and Z gates, the conditional X and Z gates can be changed to a basis most favorable to a hardware by using Hadamard gates.

Non-limiting conversion 1100 can illustrate an X-basis conversion with a conditional Z gate converted to a conditional X gate. The quantum circuit to the left of the equivalency (≡) can comprise a conditional Z gate that can be applied, for example, if a classical bit 0 has the value 1. The conditional Z gate can be converted to the conditional X, as illustrated at the right-hand side of the equivalency, by adding two Hadamard gates, wherein the conditional X gate can be applied, for example, if a classical bit 0 has the value 1. The conditional X gate can imply that a physical pulse can be applied to a system. On the contrary, non-limiting conversion 1110 can illustrate a Z-basis conversion with a conditional X gate converted to a conditional Z gate. The quantum circuit to the left of the equivalency can comprise a conditional X gate that can be applied, for example, if a classical bit 0 has the value 1. The conditional X gate can be changed to the conditional Z, as illustrated at the right-hand side of the equivalence, by adding two Hadamard gates, and the conditional z gate can be applied, for example, if a classical bit 0 has the value 1. The conditional Z gate can imply that no conditional physical pulses can be applied, and only virtual frame changes of subsequent pulses can be performed, which can be easier for some hardware.

By converting an operation such as a classically controlled Z gate to a classically controlled X gate or vice-versa, features of a hardware for executing a quantum circuit can be exploited, for example, wherein one representation can be easier to implement than another.

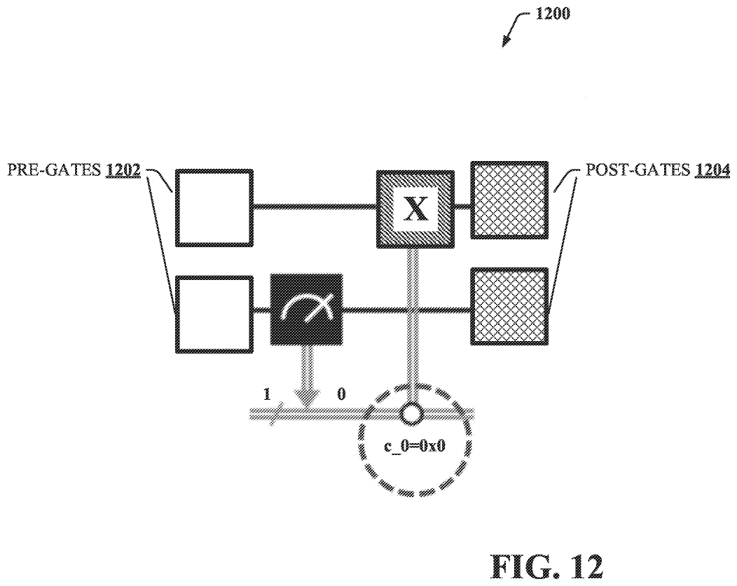

Referring now to FIGS. 12-22, aspects of twirling involved in generating the error mitigated networks of conditional gates has been described in greater detail.

FIG. 12 illustrates a diagram of an example, non-limiting portion 1200 of a quantum circuit with pre-gates and post-gates that can be implemented to perform Pauli twiring in accordance with one or more embodiments described herein. One or more embodiments described with respect to FIG. 12 can be implemented by one or more components of system 100 of FIG. 1. Repetitive description of like elements and/or processes employed in respective embodiments is omitted for sake of brevity.

In one or more embodiments, generating error mitigated networks of conditional gates in larger quantum circuits for creating virtual gates via LOCC can comprise circuit optimization (e.g., by circuit transpiler unit 108) wherein networks of conditional gates can be identified, and mid-circuit measurements that can be executed in parallel, can be placed in parallel. Upon optimizing a quantum circuit, error mitigation can be implemented into the quantum circuit, for example, via PEC. Operations for performing PEC can involve twirling of the mid-circuit measurements and classical conditionals (e.g., by circuit twirling unit 110), wherein the twirling can be performed using a set of twirling rules or extra logic. In the various embodiments herein, twirling can refer to Pauli twirling. Pauli twirling can be defined as an act of inserting single-qubit gates before and after a circuit instruction to convert a noise of the circuit instruction into a Pauli Channel. As such, inserting Pauli operations before and after a CNOT gate can convert noise associated with the CNOT gate to a Pauli channel. A Pauli channel can be a form of noise that can be relatively easier to process. Thus, twirling can reduce the noise of the CNOT gate into a form that can be easier to process.

FIG. 12 illustrates a measurement gate followed by a conditional X gate that can be applied, for example, when a value of a classical bit 0 in the classical register c can be 0, as indicated by the condition (e.g., (c_0=0x0)) inside the dashed circle. FIG. 12 further illustrates pre-gates 1202 and post-gates 1204, wherein pre-gates 1202 and post-gates 1204 can be single-qubit Pauli gates that can be respectively inserted before the measurement gate and after the conditional X gate. Pre-gates 1202 and post-gates 1204 can flip a state of the classical conditional to twirl a noise associated with the mid-circuit measurement. An aim of twirling can be to preserve a logical effect of a quantum circuit, such that after inserting pre-gates 1202 and post-gates 1204 and flipping a state of a classical conditional, the resultant quantum circuit can be the same as (e.g., logically equivalent to) the quantum circuit prior to performing the twirling (i.e., Pauli twirling), but with a more favorable noise channel. As stated elsewhere herein, Pauli twirling can make noise easier to learn and error mitigate, without removing the noise. Thus, pre-gates and post-gates (e.g., pre-gates 1202 and post-gates 1204) can be used to twirl networks of mid-circuit measurements with classically controlled single-qubit operations.

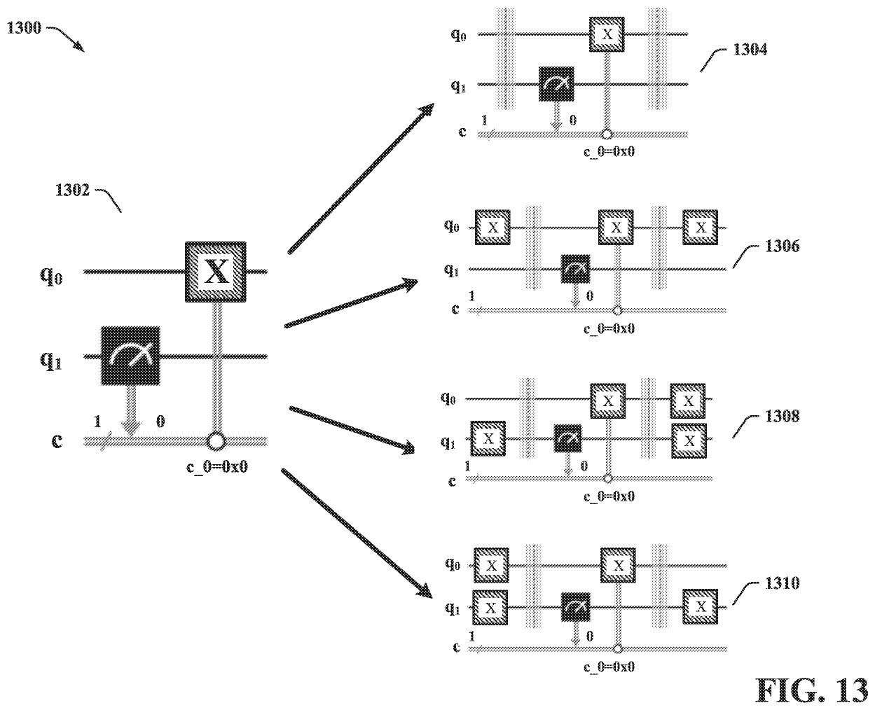

Various methods can be employed to perform twirling. For example, techniques known in the art can comprise twirling without changing the classical bit on which a quantum gate can be conditioned. In such techniques, post-gates can be adapted. Various embodiments of the present disclosure propose additional methods of twirling. In an embodiment, a classical bit on which a quantum gate can be conditioned can be changed by the twirling. In such an embodiment, post-gates can be the same as pre-gates. In another embodiment, the classical bit can be part of the twirling and post-gates can be adapted, which can avoid spreading noise through classical communication. Twirling can also be performed by splitting the twirling of a measurement and a classical conditional and twirling the classical bit. This can avoid spreading noise through classical communication and simplify twirling rules. Generally, in twirling, it is understood that a Z gate can be probabilistically inserted after the measurement. FIGS. 13-17 illustrate in greater detail, the various twirling techniques discussed herein. It is to be appreciated that although FIGS. 13-17 illustrate the twirling techniques using only X gates, twirling can be performed using other types of gates which can result in different pre-gates and post-gates.

FIG. 13 illustrates, at 1300, diagrams of example, non-limiting quantum circuits demonstrating Pauli twirling without changing a value of a classical bit in accordance with one or more embodiments described herein. One or more embodiments described with respect to FIG. 13 can be implemented by one or more components of system 100 of FIG. 1. Repetitive description of like elements and/or processes employed in respective embodiments is omitted for sake of brevity.

With continued reference to FIG. 12, twirling can be performed (e.g., by circuit twirling unit 110) without changing the classical bit on which a quantum gate can be conditioned and adapting post-gates accordingly. In FIG. 13, the condition on the classical bit can be represented by the white circle on the classical register c for each quantum circuit. Quantum circuit 1302 can have noise associated with it, and twirling can be performed on quantum circuit 1302 without changing the classical bit and inserting X gates before and after the conditional X gate (e.g., after the conditional X operation) of quantum circuit 1302 to twirl a noise of the mid-circuit measurement of quantum circuit 1302. Thus, quantum circuit 1304, quantum circuit 1306, quantum circuit 1308 and quantum circuit 1310 can be generated by inserting X gates as pre-gates and post-gates in various combinations (e.g., by circuit twirling unit 110) in quantum circuit 1302, such that quantum circuit 1304, quantum circuit 1306, quantum circuit 1308 and quantum circuit 1310 can be individually equivalent to quantum circuit 1302 without noise.

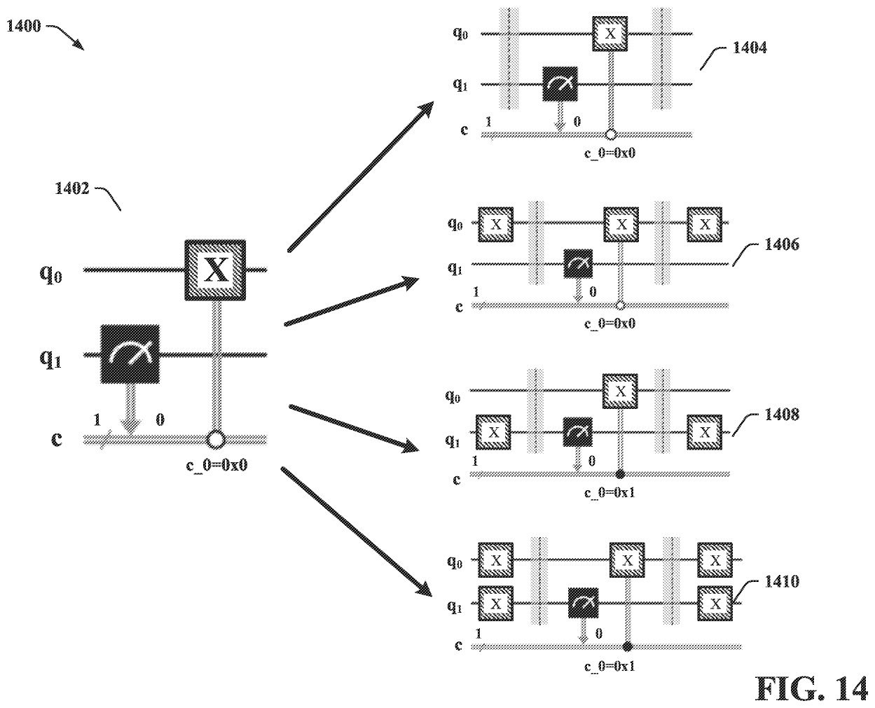

FIG. 14 illustrates, at 1400, diagrams of example, non-limiting quantum circuits demonstrating Pauli twirling by changing a value of a classical bit in accordance with one or more embodiments described herein. One or more embodiments described with respect to FIG. 14 can be implemented by one or more components of system 100 of FIG. 1. Repetitive description of like elements and/or processes employed in respective embodiments is omitted for sake of brevity.

With continued reference to FIG. 12, in one or more embodiments, a classical bit, on which a quantum gate can be conditioned, can be changed by twirling (e.g., by circuit twirling unit 110), and post-gates can remain the same as pre-gates. In such embodiments, the classical conditional (e.g., (c_0=0x0), (c_0=0x1)) can be considered as a post-gate without being a twiring parameter, and a logical effect of a quantum circuit can be preserved by manipulating classical bits in addition to using single-qubit quantum gates as pre-gate and post-gates. In FIG. 14, the classical bits can be represented by white circles or black circles (e.g., as opposed to only white circles illustrated in FIG. 12) on the classical register c for each quantum circuit. The white circles as classical bits can imply that a conditional X gate can be applied if a value of a classical bit is 0 (e.g., c_0=0x0)), whereas the black circles as classical bits can imply that the conditional X gate can be applied if a value of a classical bit is 1 (e.g., c_0=0x1)).

Thus, by flipping the conditional of quantum circuit 1402, a twirling effect can be achieved that can assist to remove certain sources of noise or symmetrize errors. As such, quantum circuit 1404 and quantum circuit 1406 can be generated by inserting X gates as pre-gates and post-gates in various combinations in quantum circuit 1402, and quantum circuit 1408 and quantum circuit 1410 can be generated by inserting X gates as pre-gates and post-gates in various combinations in quantum circuit 1402 and flipping the conditional illustrated in quantum circuit 1402, such that quantum circuit 1404, quantum circuit 1406, quantum circuit 1408 and quantum circuit 1410 can be individually equivalent to quantum circuit 1402, but comprise less noise as compared to that of quantum circuit 1402.

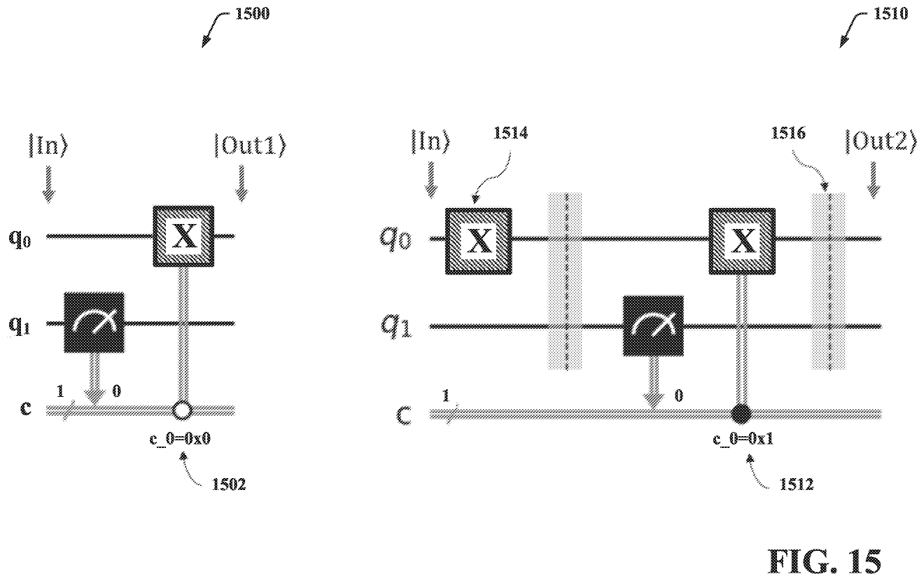

FIG. 15 illustrates diagrams of example, non-limiting quantum circuits 1500 and 1510 before and after twirling of a classical conditional associated with the quantum circuit in accordance with one or more embodiments described herein. One or more embodiments described with respect to FIG. 15 can be implemented by one or more components of system 100 of FIG. 1. Repetitive description of like elements and/or processes employed in respective embodiments is omitted for sake of brevity.

With continued reference to FIG. 14, FIG. 15 illustrates how twirling of a classical conditional of a quantum circuit can be accomplished (e.g., by circuit twirling unit 110) in one or more embodiments. For example, non-limiting quantum circuit 1500 (hereinafter, quantum circuit 1500) can comprise a conditional X gate corresponding to classical conditional 1502. In quantum circuit 1500, the conditional X gate (or classically conditioned X bit) can be applied if an outcome of a measurement performed by the measurement gate can be zero, as indicated by the classical conditional 1502. Non-limiting quantum circuit 1510 (hereinafter, quantum circuit 1510) can be a realization of a twirl in which X gate 1514 can be applied to qubit q₀. An effect of the twirling gate (e.g., X gate 1514) can be corrected by changing the classical conditional 1502 wherein the conditional X gate can be applied when a value of the classical bit c is 0 to classical conditional 1512 wherein the conditional X gate can be applied when a value of the classical bit c is 1. In doing so quantum circuit 1510 can have the same relation between an input (|In [symbol] ) and an output (|Out2 [symbol] ) as the input (|In [symbol] ) and output (|Out1 [symbol] ) of quantum circuit 1500. In other words, by changing classical conditional 1502 to classical conditional 1512, the conditional gate X can be converted from being conditional on value 0 to being conditional on value 1, while ensuring that quantum circuit 1500 and quantum circuit 1510 can output the same logical operation.

Table 1 can list input and output values of quantum circuit 1500 and quantum circuit 1510 to further describe the concept. The first value in each cell can correspond to q₁ and the second value can correspond to q₀, as further clarified by the ordering of qubit names in column 1 of table 1. For example, in column 2, row 1, q₁ and q₀ can both have input values of 0, whereas in column 2, row 2, q₁ can have an input value of 0 and q₀ can have an input value of 1.

TABLE 1

| \|In> | \|In> | \|Out1> | \|Out2> |
|---|---|---|---|
| (q₁, q₀) | (0, 0) | (0, 1) | (0, 1) |
| (q₁, q₀) | (0, 1) | (0, 0) | (0, 0) |
| (q₁, q₀) | (1, 0) | (1, 0) | (1, 0) |
| (q₁, q₀) | (1, 1) | (1, 1) | (1, 1) |

In summary, quantum circuit 1500 can be equivalent to quantum circuit 1510. It is to be noted that while quantum circuit 1510 can have a pre-gate (e.g., X gate 1514), quantum circuit 1510 can have no post gates (e.g., to the right of barrier 1516). Instead, classical conditional 1512 can correct for the pre-gate.

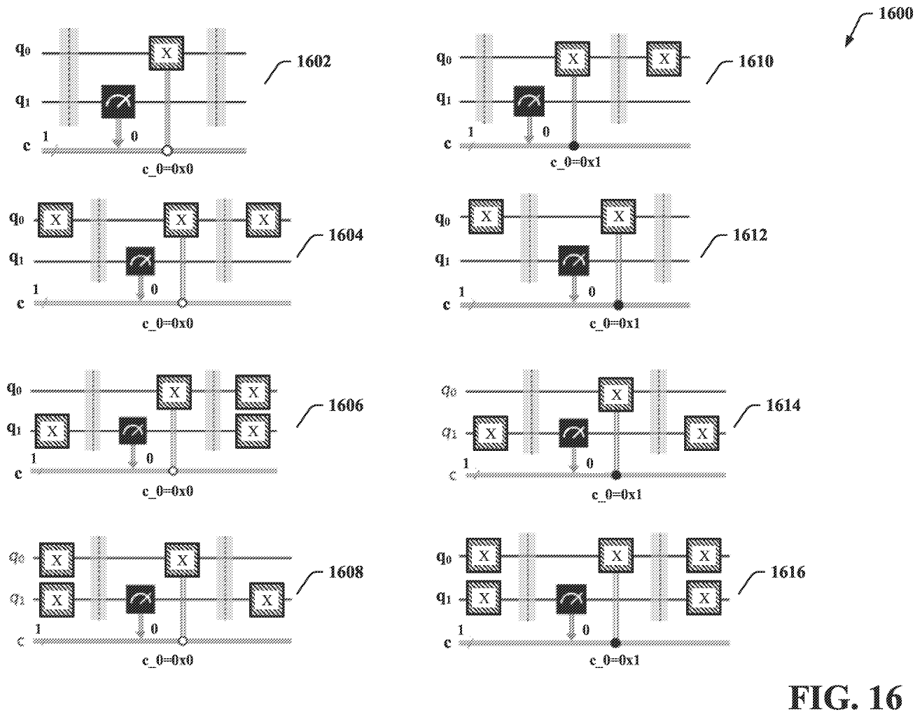

FIG. 16 illustrates, at 1600, diagrams of example, non-limiting quantum circuits demonstrating Pauli twirling by application of a post-gate in accordance with one or more embodiments described herein. One or more embodiments described with respect to FIG. 16 can be implemented by one or more components of system 100 of FIG. 1. Repetitive description of like elements and/or processes employed in respective embodiments is omitted for sake of brevity.

With continued reference to FIG. 12, in one or more embodiments, a classical bit can be part of twirling and post-gates can be adapted, which can avoid spreading noise through classical communication. That is, a classical conditional can be a twirling parameter and post-gates can also be used to perform twirling (e.g., by circuit twirling unit 110), resulting in 8 possible twirling circuits, as illustrated in FIG. 16. For example, quantum circuit 1602, quantum circuit 1604, quantum circuit 1606, quantum circuit 1608, quantum circuit 1610, quantum circuit 1612, quantum circuit 1614 and quantum circuit 1616 can be sampled to twirl noise in a quantum circuit (e.g., quantum circuit 1302, quantum circuit 1402), considering only X gate twirls. Although not illustrated in FIG. 16, quantum circuits 1602, 1604, 1604, 1608, 1610, 1612, 1614 and 1616 can be logically equivalent to quantum circuit 1302 (or quantum circuit 1402), however, by averaging over the various implementations, the noise in quantum circuit 1302 (or quantum circuit 1402) can be symmetrized and made easier to deal with. As stated earlier, although the twirling techniques described in one or more embodiments are illustrated using only X gates, twirling can be performed using other types of gates which can result in different pre-gates and post-gates.

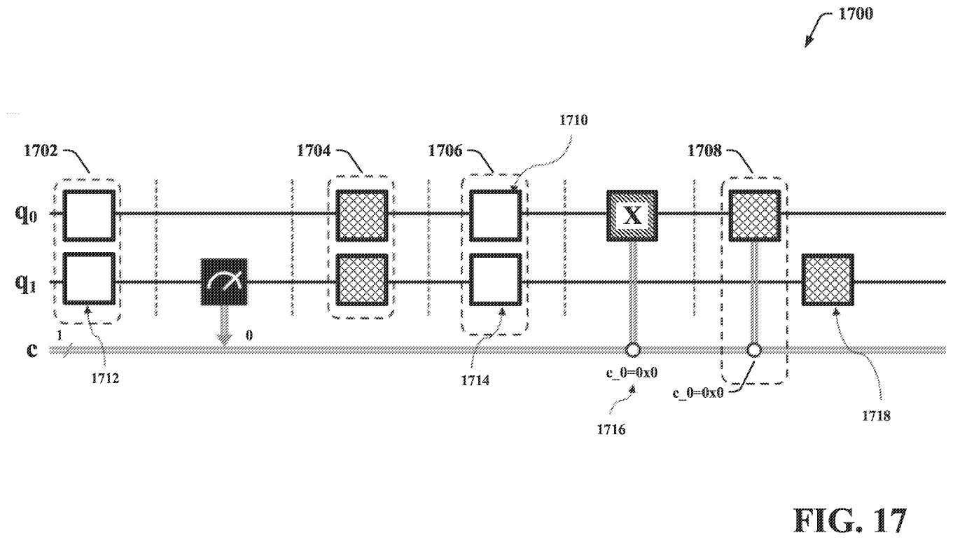

FIG. 17 illustrates a diagram of an example, non-limiting quantum circuit 1700 demonstrating Pauli twirling via a split twirl in accordance with one or more embodiments described herein. One or more embodiments described with respect to FIG. 17 can be implemented by one or more components of system 100 of FIG. 1. Repetitive description of like elements and/or processes employed in respective embodiments is omitted for sake of brevity.

With continued reference to FIG. 12, in one or more embodiments, twirling can also be performed by splitting the twirling of a mid-circuit measurement and a classical conditional and twirling the classical bit. This can avoid spreading noise through classical communication and simplify twirling rules. FIG. 17 can illustrate an embodiment of a split twirl in which a mid-circuit measurement and a conditional X gate can be twirled separately, and the classical conditional can also be twirled. For example, in non-limiting quantum circuit 1700 (hereinafter, quantum circuit 1700), classical conditional 1716 can be twirling parameter. In different twirling circuits, the conditional X gate can be applied if classical conditional 1716 can be based on being true or false.

In FIG. 17, pre-gates 1702 and post-gates 1704 can be respective pre-gates and post-gates for the mid-circuit measurement of quantum circuit 1700, and pre-gates 1706 and post-gate 1708 can be respective pre-gates and post-gate for the conditional X gate of quantum circuit 1700. Post-gates 1704 of the mid-circuit measurement can depend on the pre-gates 1702 of the mid-circuit measurement, and post-gate 1708 of the conditional X gate can depend on the pre-gate 1710, the pre-gate 1712 of the measurement, and the classical conditional 1716. The post-gate 1718 can depend only on the pre-gate 1714. FIG. 17 can illustrate that mid-circuit measurements and classical conditionals can be twirled independently, for example, as opposed to twirling a measurement and a classical conditional as one block, as illustrated in FIGS. 12-16. Although not illustrated in FIG. 17, quantum circuit 1700 can be logically equivalent to quantum circuit 1302 (or quantum circuit 1402).

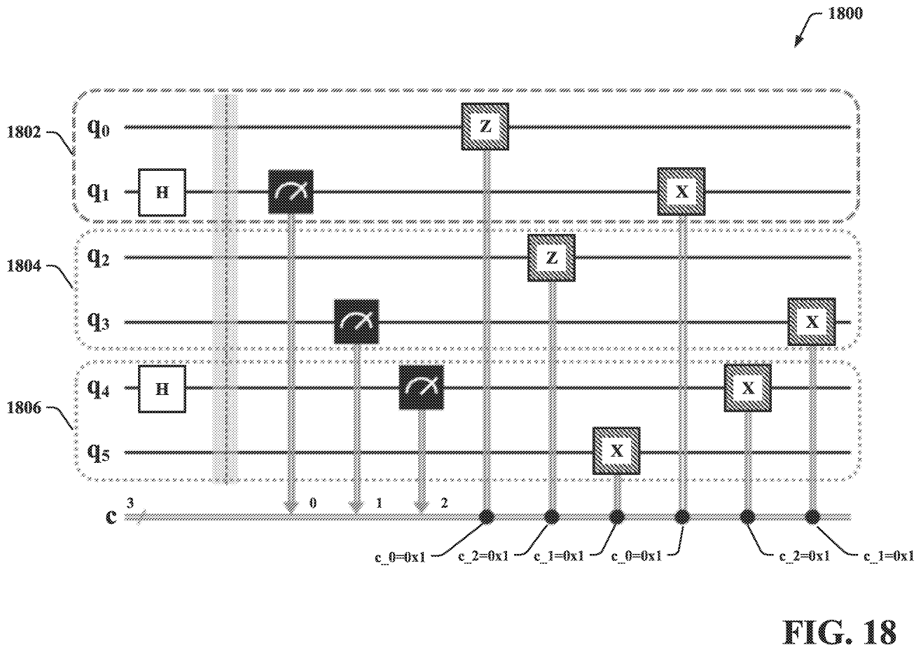

FIG. 18 illustrates a diagram of an example, non-limiting quantum circuit 1800 identifying measurements that can be performed in parallel for enabling virtual gates with LOCC in accordance with one or more embodiments described herein. One or more embodiments described with respect to FIG. 18 can be implemented by one or more components of system 100 of FIG. 1. Repetitive description of like elements and/or processes employed in respective embodiments is omitted for sake of brevity.

FIG. 18 can illustrate an example of an X-basis measurement of a virtual controlled single-qubit gate (block 1802) and two measurements of a virtual CNOT gate (block 1804 and block 1806), wherein the X-basis measurement and the two measurements of the virtual CNOT gate can be placed in parallel to minimize context switching latencies. Further, block 1802 can correspond to a target qubit of the virtual controlled single qubit-gate, block 1804 can correspond to a target qubit of the virtual CNOT gate and block 1806 can correspond to a control qubit of the virtual CNOT gate. As stated elsewhere herein, virtual gates with LOCC can lead to complex networks of measurements and conditionals within a larger quantum circuit, such as non-limiting quantum circuit 1800 (hereinafter, quantum circuit 1800).

For example, quantum circuit 1800 can comprise a network of gates with three mid-circuit measurements that can be performed in parallel. For generating virtual gates with LOCC, mid-circuit measurements can be placed in parallel, resulting in complicated networks of multiple mid-circuit measurements and multiple classically controlled single-qubit gates, for example, as opposed to a single mid-circuit measurement and a single classically controlled single-qubit gate. As such, twirling and error mitigation can involve situations, such as illustrated in quantum circuit 1800, to be accommodated for implementing error mitigated virtual gates via LOCC. It is to be appreciated that quantum circuit 1800 can illustrate three qubit pairs, wherein qubits q₀ and q₁ can form a first pair, qubits q₂ and q₃ can form a second pair and qubits q₄ and q₅ can form a third pair, and wherein each pair of qubits can be on a different QPUs or at different locations within a single QPU.

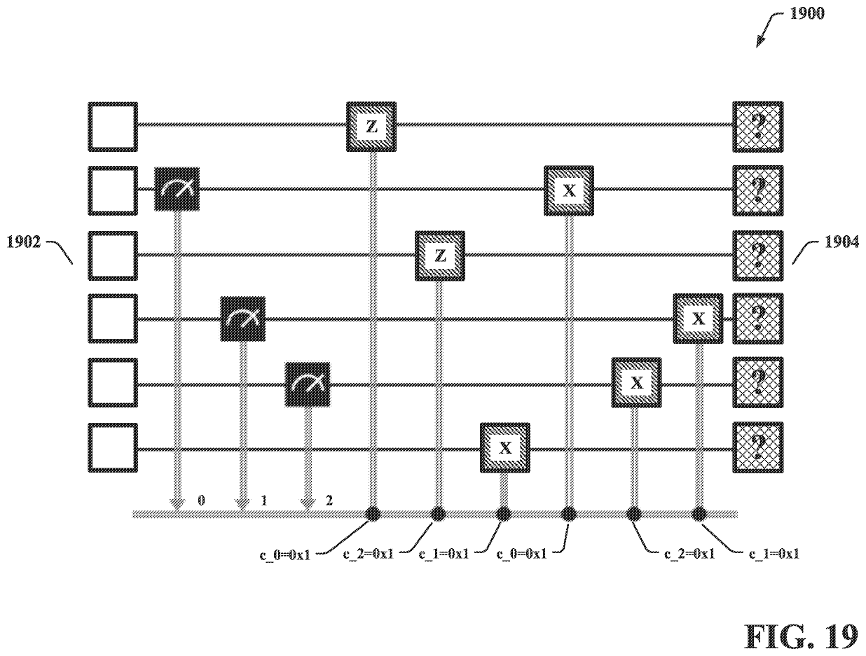

FIG. 19 illustrates a diagram of an example, non-limiting quantum circuit 1900 showing pre-gates and twirls that can be used to determine post-gates in accordance with one or more embodiments described herein. One or more embodiments described with respect to FIG. 19 can be implemented by one or more components of system 100 of FIG. 1. Repetitive description of like elements and/or processes employed in respective embodiments is omitted for sake of brevity.

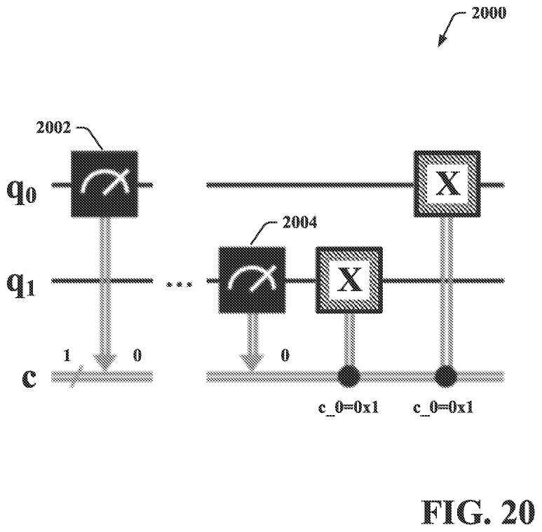

FIG. 19 can illustrate an example of an X-basis measurement of a virtually controlled single-qubit gate and two measurements of a virtual CNOT gate in non-limiting quantum circuit 1900 (hereinafter, quantum circuit 1900), wherein the X-basis measurement and the two measurements of the virtual CNOT gate can be placed in parallel to minimize context switching latencies. As stated elsewhere herein, virtual gates with LOCC can lead to complex networks of measurements and conditionals within a larger quantum circuit, such as quantum circuit 1900. Quantum circuit 1900 can be identical to quantum circuit 1800, and quantum circuit 1900 can comprise pre-gates 1902 and post-gates 1904, wherein post-gates 1904 can be determined based on pre-gates 1902 and twirls performed on classical conditionals. An algorithmic approach to determine post-gates in twirling can be adopted, based on knowledge of a relationship between measured qubits, control classical bits and target qubits, additional aspects of which can be further disclosed with reference to FIGS. 20-22.

FIG. 20 illustrates a diagram of an example, non-limiting quantum circuit 2000 in accordance with one or more embodiments described herein. One or more embodiments described with respect to FIG. 20 can be implemented by one or more components of system 100 of FIG. 1. Repetitive description of like elements and/or processes employed in respective embodiments is omitted for sake of brevity.

With continued reference to FIG. 19, an algorithmic solution for X gate twirls can comprise performing a Breadth First Search (BFS) in a directed acyclic graph (DAG) to determine a relationship between measured qubits, classical bits, and target qubits, converting a conditional sub-circuit to a Clifford equivalent circuit, and using the Clifford equivalent circuit to efficiently determine post-gates from pre-gates. In one or more embodiments, such a methodology can also be compatible with a random Z gate insertion after a measurement. BFS can be a method to perform a search algorithm in a tree, wherein the search can proceed horizontally in the tree. BFS can opposite to a depth first search (DFS), wherein the search can proceed vertically down in the tree first before back tracking into other branches.

BFS can assist in preserving an order of operations in a quantum circuit because a simple mapping of which qubit is measured into which classical bit can exclude considerations of classical bit re-use. For example, in non-limiting quantum circuit 2000 (hereinafter, quantum circuit 2000), mid-circuit measurement 2002 and mid-circuit measurement 2004 can both store their results in the same classical bits. However, mid-circuit measurement 2002 can be unrelated to the two conditional X gates (or classically controlled X gates) illustrated in quantum circuit 2000, and incorrect mapping of mid-circuit measurements 2002 and 2004 to the classical conditionals can cause mid-circuit measurement 2002 to be mapped as being related to the two conditional X gates. Thus, when re-using classical bits, an entity can aim to ensure that mid-circuit measurements and classical conditionals are related correctly (e.g., in a clever manner) to determine which mid-circuit measurements control which classical conditionals. Incorrect mapping of mid-circuit measurements and classical conditionals can be prevented by employing BFS. For example, quantum circuit 2000 can be represented by a DAG, and a BFS search in the DAG can be performed to determine a relationship between measured qubits, classical bits, and target qubits. As discussed in one or more embodiments, the relationship between the measured qubits, the classical bits, and the target qubits can assist circuit twirling unit 110 in determining twirling circuits towards implementation of error mitigated virtual gates via LOCC.

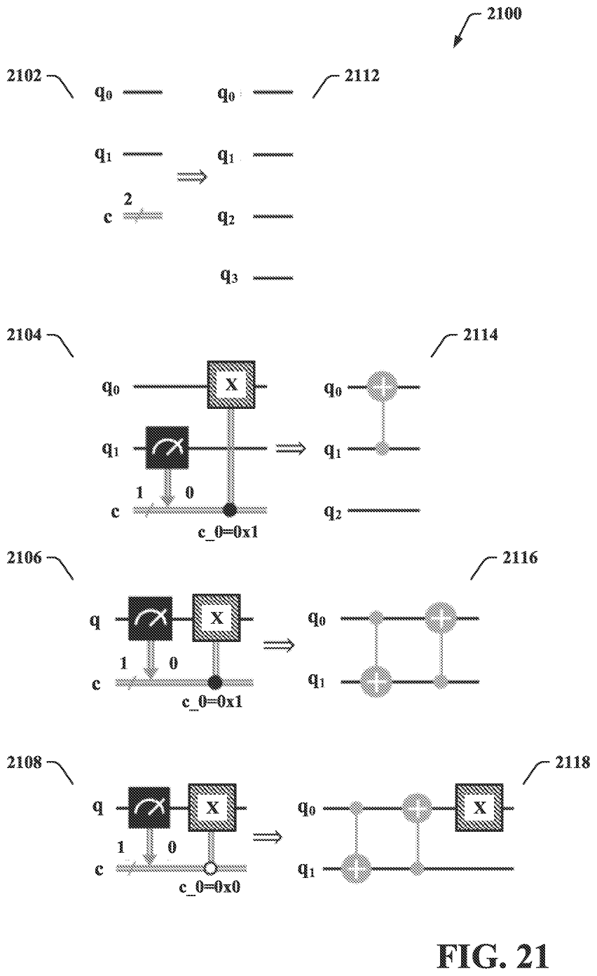

FIG. 21 illustrates, at 2100, diagrams of example, non-limiting representations of Clifford equivalent circuits in accordance with one or more embodiments described herein. One or more embodiments described with respect to FIG. 21 can be implemented by one or more components of system 100 of FIG. 1. Repetitive description of like elements and/or processes employed in respective embodiments is omitted for sake of brevity.

As discussed with reference to FIG. 20, an algorithmic solution for X gate twirls can comprise performing a BFS in a DAG to determine a relationship between measured qubits, classical bits, and target qubits, converting a conditional sub-circuit to a Clifford equivalent circuit, and using the Clifford equivalent circuit to efficiently determine post-gates from pre-gates. In one or more embodiments, such a methodology can also be compatible with a random Z gate insertion after a measurement. A Clifford equivalent circuit can allow for determination of twirling rules when only X gates and classical bit twirls are used.

A Clifford equivalent circuit can be constructed for a network of measurements and conditional X gates. As stated elsewhere herein, conditional Z gates can be constructed from conditional X gates (e.g., by using Hadamard gates) and vice-versa. The following rules can be considered for construction of a Clifford equivalent circuit:

1. Each classical bit in a quantum circuit can be replaced with an ancilla qubit.

2. A classically controlled X gate can be equivalent to a CNOT gate when the measured qubit and target qubit are different.

3. A classically controlled X gate can be equivalent to two CNOT gates with a first CNOT gate between the measured qubit and an ancilla qubit, and a second CNOT gate between the ancilla and the target qubit.

4. A conditional on a 0 in a classical bit can be equivalent to a conditional on a 1 in the classical bit with an extra X gate on the target qubit.

Thus, a network of mid-circuit measurements and classically controlled single qubit X gates can be represented by CNOT gates, some ancilla qubits and single qubit X gates to form a Clifford equivalent circuit. For example, quantum circuit 2102 can be converted to Clifford equivalent circuit 2112 by replacing classical bits with ancilla qubits q₂ and q₃. Quantum circuit 2104 can be converted to Clifford equivalent circuit 2114 by replacing the classical bit in quantum circuit 2104 with ancilla qubit q₂ and replacing the classically controlled X gate with a CNOT gate (e.g., on account of the measured qubit (q₁) and the target qubit (q₀) being different in quantum circuit 2104). Quantum circuit 2106 can be converted to Clifford equivalent circuit 2116 by replacing the classical bit in quantum circuit 2106 with an ancilla qubit q₁, and by replacing the classically controlled X gate with a first CNOT gate between the measured qubit and an ancilla qubit and a second CNOT gate between the ancilla and the target qubit. Quantum circuit 2108 can be converted to Clifford equivalent circuit 2118 by replacing the classical bit in quantum circuit 2108 with an ancilla qubit q₁ and an extra X gate on the target qubit (e.g., on account of the conditional on the 0 in the classical bit of quantum circuit 2108 being equivalent to a conditional on a 1 in the classical bit of quantum circuit 2118 with an extra X gate), and by replacing the classically controlled X gate with a first CNOT gate between the measured qubit and an ancilla qubit and a second CNOT gate between the ancilla and the target qubit.

As discussed above, a Clifford equivalent circuit can provide a convenient method of determining pre-gates and post-gates towards twirling. That is, a Clifford equivalent circuit can be easily leveraged to determine post-gates based on pre-gates. An ancilla qubit can imply an extra qubit such that for each bit in a classical register, an ancilla qubit can be added.

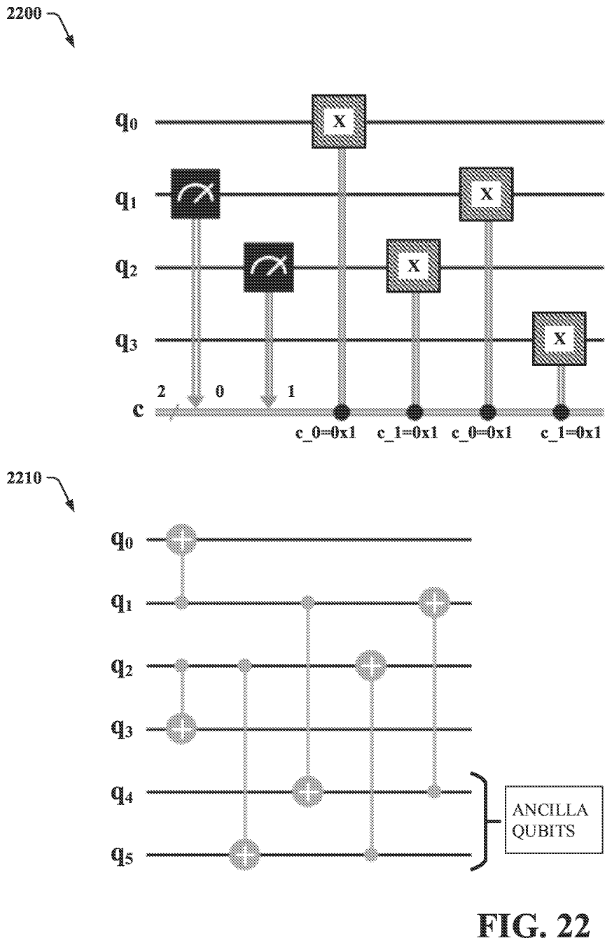

FIG. 22 illustrates diagrams of example, non-limiting quantum circuits 2200 and 2210 comprising a circuit with a network of mid-circuit measurements and classically controlled X gates and a Clifford equivalent circuit of the circuit with the mid-circuit measurements and the classically controlled X gates in accordance with one or more embodiments described herein. One or more embodiments described with respect to FIG. 22 can be implemented by one or more components of system 100 of FIG. 1. Repetitive description of like elements and/or processes employed in respective embodiments is omitted for sake of brevity.

In one or more embodiments, non-limiting quantum circuit 2200 (hereinafter, quantum circuit 2200) can be a teleportation circuit converted to an X gate basis, and non-limiting quantum circuit 2210 (hereinafter, quantum circuit 2210) can be a Clifford equivalent circuit of quantum circuit 2200, as illustrated in FIG. 22. In quantum circuit 2210, ancilla qubits q₄ and q₅ can represent classical bits from quantum circuit 2200. As such, quantum circuit 2200 can illustrate a network of measurements and feed-forward operations and quantum circuit 2210 can illustrated the equivalent Clifford circuit. Clifford equivalent circuits such as quantum circuit 2210 can be used to determine post-gates, post X rotations, etc. It is to be appreciated that Hadamard gates are not illustrated in FIG. 22.

FIG. 23 illustrates a diagram of an example, non-limiting representation 2300 of performing dynamical decoupling in a quantum circuit in accordance with one or more embodiments described herein. One or more embodiments described with respect to FIG. 23 can be implemented by one or more components of system 100 of FIG. 1. Repetitive description of like elements and/or processes employed in respective embodiments is omitted for sake of brevity.

In one or more embodiments, generating error mitigated networks of conditional gates in larger quantum circuits for creating virtual gates via LOCC can comprise circuit optimization (e.g., by circuit transpiler unit 108) wherein networks of conditional gates can be identified, and mid-circuit measurements that can be executed in parallel, can be placed in parallel. Upon optimizing a quantum circuit, error mitigation can be implemented into the quantum circuit, for example, via PEC. Operations for performing PEC can comprise twirling (e.g., by circuit twirling unit 110) of the mid-circuit measurements and classical conditionals, wherein the twirling can be performed by using a set of twirling rules or extra logic. Another aspect of error mitigation can comprise insertion of dynamical decoupling pulse sequences (e.g., by dynamical decoupling pulse sequence insertion unit 112) during idle times of qubits to correct phase errors, cross-talks, etc.

Dynamical decoupling can comprise inserting a sequence of gates that can decouple a system from an environment of the system that can be responsible for introducing noise into the system. Thus, dynamical decoupling can be described as a form of error suppression. During dynamical decoupling, dynamical decoupling pulse sequences can be inserted (e.g., by dynamical decoupling pulse sequence insertion unit 112) during both, standard idle times (e.g., illustrated in FIG. 4 as rectangles with dashed lines), and context switching idle times (e.g., illustrated in FIG. 4 as vertical dashed lines) of qubits. Within a quantum circuit, there can be multiple context switches and idle durations, however, a single idle duration can only have one dynamical decoupling pulse sequence inserted. A typical sequence used for dynamical decoupling can involve a pair of X gates, which has been illustrated in FIG. 23. In some embodiments, another entity can be used instead of a pair of X gates.

Dynamical decoupling pulse sequences can be tailored to hardware and circuit instructions being executed. For example, dynamical decoupling pulse sequences can be different when measuring neighboring qubits, when qubits can be running gates, or when qubits can be simply idling. During idle times in a quantum circuit, dynamical decoupling pulse sequences can be inserted, which can assist with decoupling and suppressing errors. Dynamical decoupling can be accomplished in different ways. In the various embodiments discussed herein, dynamical decoupling can be performed within LOCC circuits.

FIG. 23 illustrates a quantum circuit represented in schedule format. The quantum circuit can comprise H gate 2302 followed by CNOT gate 2304 between qubits q₀ and q₁, CNOT gate 2306 between qubits q₁ and q₂ and CNOT gate 2310 between qubits q₂ and q₃. CNOT gates 2304, 2306 and 2310 are illustrated as having different widths because the respective widths of each of CNOT gate 2304, CNOT gate 2306 and CNOT gate 2310 can represent a duration of the respective CNOT gate. In the quantum circuit of FIG. 23, dynamical decoupling can refer to insertion of the two X gates illustrated at 2308, generating an effect of cancelling and inverting some noise associated with CNOT gate 2306 and CNOT gate 2310. In FIG. 23, the horizontal axis can represent a system cycle time. It is to be appreciated that the non-limiting representation 2300 is not to scale.

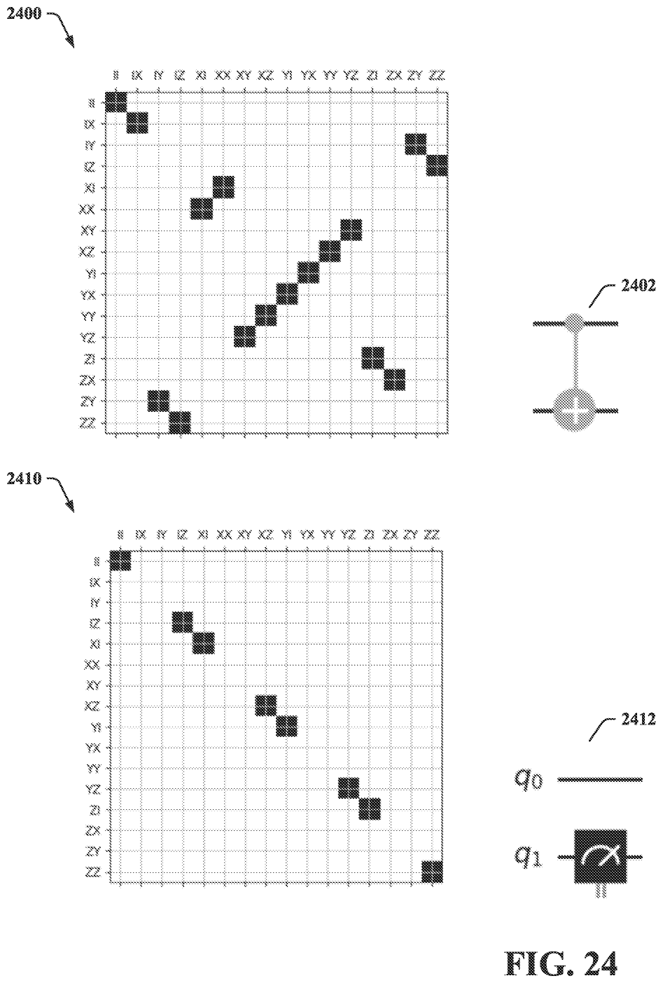

FIG. 24 illustrates diagrams of example, non-limiting Pauli transfer matrices 2400 and 2410 that can be used for learning a noise model of circuit instructions in accordance with one or more embodiments described herein. One or more embodiments described with respect to FIG. 24 can be implemented by one or more components of system 100 of FIG. 1. Repetitive description of like elements and/or processes employed in respective embodiments is omitted for sake of brevity.

In one or more embodiments, generating error mitigated networks of conditional gates in larger quantum circuits for creating virtual gates via LOCC can comprise circuit optimization (e.g., by circuit transpiler unit 108) wherein networks of conditional gates can be identified, and mid-circuit measurements that can be executed in parallel, can be placed in parallel. Upon optimizing a quantum circuit, error mitigation can be implemented into the quantum circuit, for example, via PEC. Operations for performing PEC can involve twirling of the mid-circuit measurements and classical conditionals, wherein the twirling (e.g., by circuit twirling unit 110) can be performed using a set of twirling rules or extra logic. Another aspect of error mitigation can comprise insertion of dynamical decoupling pulse sequences (e.g., by dynamical decoupling pulse sequence insertion unit 112) during idle times of qubits to correct phase errors, cross-talks, etc.

Yet another aspect of the error mitigation can comprise sparse noise model learning (e.g., by noise learning unit 116), wherein noise generated in a quantum circuit (e.g., in a quantum circuit resulting from insertion of the dynamical decoupling pulse sequences) can be learnt and inverted. Noise model learning can enable isolation of noise that can be associated with a quantum gate or mid-circuit measurements and transforming the noise into a Pauli channel. During noise model learning, a sparse noise model of circuit instructions that can be twirled can be learnt (e.g., by noise learning unit 116) by exploiting a non-full rank Pauli Transfer Matrix. While a full-rank matrix can be desirable for noise model learning, a Pauli Transfer Matrix associated with a measurement can be diagonal but not full-rank.

In FIG. 24, Pauli Transfer Matrix 2400 can be a full-rank Pauli Transfer Matrix of a CNOT gate, such as the CNOT gate illustrated at 2402. Pauli Transfer Matrix 2400 can be a representation of actions performed by the CNOT gate and a noise associated with the CNOT gate. Pauli Transfer Matrix 2400 can be determined by characterizing the CNOT gate and performing quantum process tomography. Further, Pauli Transfer Matrix 2410 can be a rank-deficient Pauli Transfer Matrix of a measurement and one idle qubit in parallel, such as illustrated at 2412. In Pauli Transfer Matrix 2400 and Pauli Transfer Matrix 2410, the top axes can represent respective input Pauli operators, and the left axes can represent respective output Pauli operators. It is to be appreciated that Pauli Transfer Matrix 2400 and Pauli Transfer Matrix 2410 can illustrate one of various representations that a Pauli Transfer Matrix can be chosen from.

Unlike for quantum gates, a Pauli Transfer Matrix of a measurement (or network thereof) can be rank deficient (i.e., not full rank). Thus, a different approach to noise model learning (e.g., as compared to an approach for a full-rank matrix) can be suitable based on the rank deficiency of Pauli Transfer Matrix 2410 to guarantee a small value for y. As discussed in one or more embodiments herein, PEC can be implemented via quasi-probability decomposition. Quasi-probability decomposition can be defined as a decomposition of a quantum channel ε as a sum over other quantum channels ε(ρ)=Σᵢ aᵢεᵢ(ρ). The coefficients aᵢ in the sum can form a quasi-probability distribution and can be converted to a proper probability distribution

$$ℰ ( ρ ) = γ {\sum }_{i} \frac{\vert {a}_{i} \vert}{γ} sign ( {a}_{i} ) {ℰ}_{i} ( ρ )$$

at the cost of a sampling overhead. Herein, γ=Σ|aᵢ| can measure the sampling overhead γ². It is to be appreciated that both, cut Bell pairs and PEC can be implemented with quasi-probability decompositions, and a cost of LOCC quasi-probability decomposition for implementing virtual gates can also be measured with a y.

In case of learning a sparse noise model based on a full-rank matrix, a vector of fidelities f for Paulis in a set [symbol] can be measured on the hardware. A Pauli Transfer Matrix M of an ideal gate desired to be implemented can be known, and the goal can be to find weights A of the sparse noise model that can best fit the data. Equation 1 can be solved by performing linear least squares minimization as described in equation 2, and since M can be full-rank, a solution to equation 1 can be unique.

Vectors of fidelities can correspond to a separate experiment that can be conducted to perform PEC. For example, performing PEC can comprise learning a noise channel or a desired channel by performing an experiment that can have, as a result, fidelities that can be measured. In this case, fidelities can correspond to diagonal elements of the Pauli Transfer Matrix. The vector of fidelities can be a way to characterize a noise channel.

$$- \frac{log ( f )}{2} = M λ \qquad Equation 1$$

$$λ ( f ) := arg min \frac{1}{2} {‖ M λ + \frac{log ( f )}{2} ‖}_{2}^{2} \qquad Equation 2$$

Thus, learning a sparse noise model can be based on a full-rank matrix. For example, a noise channel of a CNOT gate that can be Pauli twirled can correspond to a Pauli Transfer Matrix that can be a full-rank matrix, as illustrated by Pauli Transfer Matrix 2400. However, twirling measurements on quantum gates can generate a Pauli Transfer Matrix that can be non-full rank (i.e., rank deficient), which is represented in Pauli Transfer Matrix 2410 by missing black squares on the diagonal formed by the black squares. Stated differently, learning noise of a mid-circuit measurement that is not unitary can be challenging since a Pauli Transfer Matrix of the mid-circuit measurement can be rank deficient, resulting in many solutions (e.g., λ) to an optimization problem of what the noise channel can look like. With reference to equation 1, for mid-measurements, M can be rank deficient and the solution noise model A can be non-unique, which can lead to a large value of ∥λ∥₁. This can increase a cost of performing error mitigation.

A solution to the above problem can include measuring on hardware, a vector of fidelities f for Paulis in a set [symbol] . As in the case of a full-rank metrix, the Pauli Transfer Matrix M of an ideal gate desired to be implemented can be known, and the goal can be to find weights A of the sparse noise model that can best fit the data. In an embodiment, equation 1 can be solved by restricting the Paulis. In another embodiment, equation 1 can be solved by performing Lasso regularization and solving the minimization

$${min}_{λ \geq 0} {‖ M λ - f ‖}_{2}^{2} + c {‖ λ ‖}_{1} .$$

The resulting noise model can minimize the cost of performing PEC. The optimization problem can be a minimization of the expression (Mλ−f) with a constraint that λ is positive, wherein λ represents coefficients of the noise model, which can lead to many solutions for a measurement. This can be resolved by adding another condition comprising minimizing the 1-norm of λ which can further minimize the overhead. Thus, the rank deficient matrix can allow for learning of a noise model of a mid-circuit measurement by performing a linear least squares minimization by selecting solutions having the smallest values of the noise.

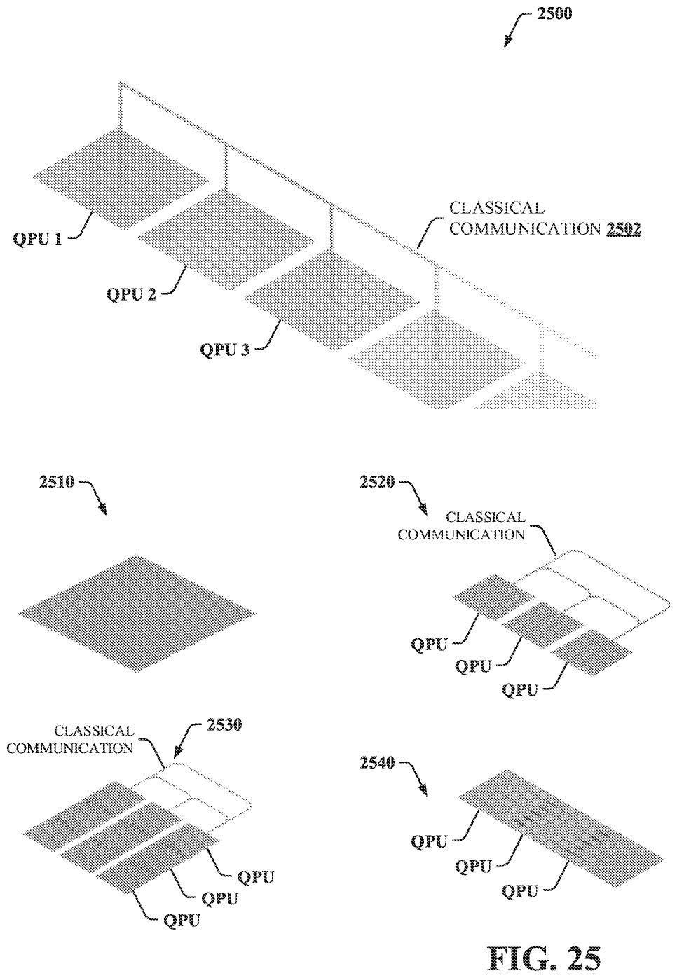

FIG. 25 illustrates, at 2500, a diagram of an example, non-limiting representation of quantum computing via classical communication in accordance with one or more embodiments described herein. Repetitive description of like elements and/or processes employed in respective embodiments is omitted for sake of brevity.

In one or more embodiments discussed herein, error mitigated networks of conditional gates can be generated in larger quantum circuits to create virtual gates via LOCC. Such virtual gates can allow multiple smaller QPUs to communicate via classical communication and function as a single large QPU. For example, QPU 1, QPU2, QPU 3, and so on, can communicate through classical communication 2502 to function as a single large QPU, wherein classical communication 2502 can be enabled by the virtual gates. In the representation illustrated at 2500, a single QPU can comprise 133 qubits, and the larger system can comprise 133×p qubits, wherein p can represent the number of QPUs that can be connected through classical communication.

FIG. 25 further illustrates, at 2510, 2520, 2530 and 2540, additional combinations of QPUs communicating through classical communication. The combination at 2510 can comprise 1121 qubits, the combination at 2520 can comprise over 1386 qubits, the combination at 2530 can comprise over 4158 qubits and the representation at 2540 can comprise 408 qubits. Classical and quantum communication in combination can allow systems to be scaled up to 10,000-100,000 qubits.

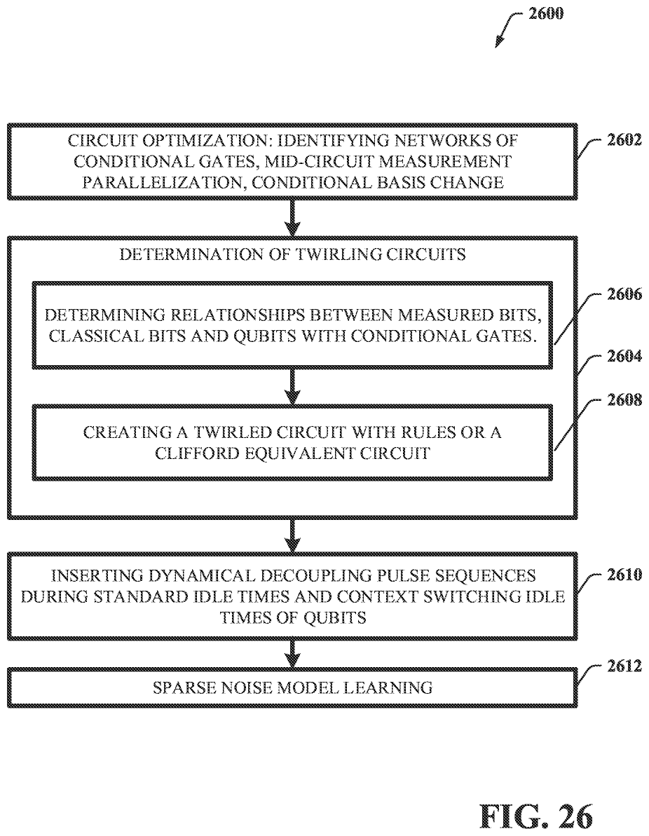

FIG. 26 illustrates a flow diagram of an example, non-limiting method 2600 that can generate error mitigated networks of conditional gates to enable virtual gates via LOCC in accordance with one or more embodiments described herein. One or more embodiments described with respect to FIG. 26 can be implemented by one or more components of system 100 of FIG. 1. Repetitive description of like elements and/or processes employed in respective embodiments is omitted for sake of brevity.

At 2602, the non-limiting method 2600 can comprise circuit optimization of a quantum circuit. The circuit optimization can comprise identifying networks of conditional gates, parallelization of mid-circuit measurements and conditional basis changes.

At 2604, the non-limiting method 2600 can comprise determination of twirling circuits.

At 2606, the non-limiting method 2600 can comprise determining relationships between measured bits, classical bits and qubits with conditional gates.

At 2608, the non-limiting method 2600 can comprise creating a twirled circuit with rules or a Clifford equivalent circuit.

At 2610, the non-limiting method 2600 can comprise inserting dynamical decoupling pulse sequences during standard idle times and context switching idle times of qubits.

At 2612, the non-limiting method 2600 can comprise sparse noise model learning.

In one or more embodiments, non-limiting method 2600 can be a computer-implemented method that can comprise receiving a quantum circuit on a plurality of qubits, creating a modified quantum circuit from the quantum circuit by arranging at least two mid-circuit measurements on at least two qubits to occur coincidentally, determining a plurality of twirling circuits for unmeasured circuits, inserting the plurality of twirling circuits into the modified quantum circuit to create an executable quantum circuit, and performing the quantum circuit on a quantum computer. In the computer-implemented method of non-limiting method 2600, the at least two qubits can comprise virtual qubits encoded over multiple physical qubits.

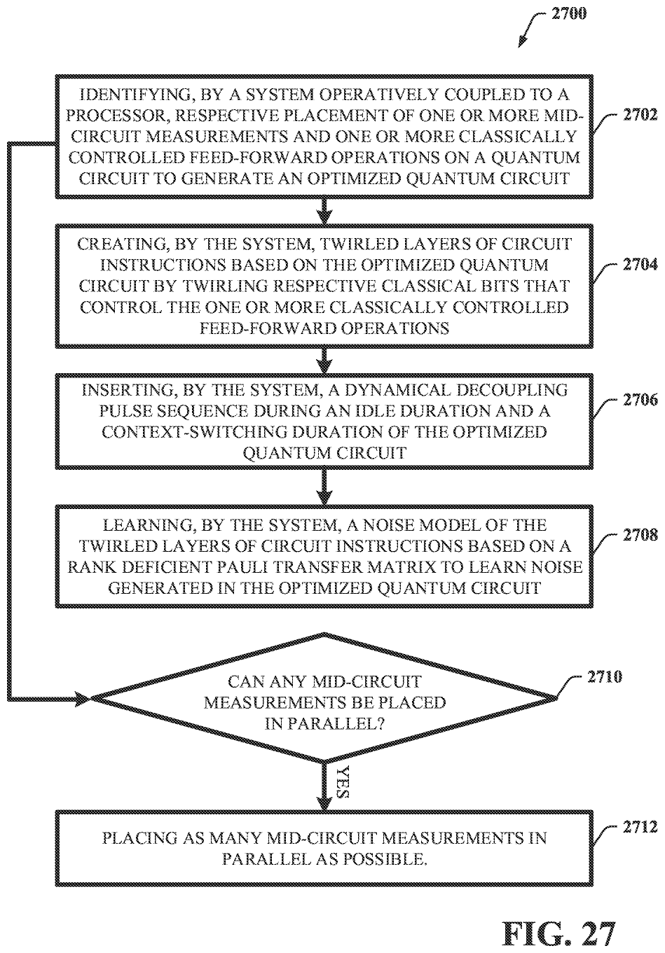

FIG. 27 illustrates a flow diagram of an example, non-limiting method 2700 that can generate error mitigated networks of conditional gates to enable virtual gates via LOCC in accordance with one or more embodiments described herein. Repetitive description of like elements and/or processes employed in respective embodiments is omitted for sake of brevity.

At 2702, the non-limiting method 2700 can comprise identifying (e.g., by circuit transpiler unit 108), by a system operatively coupled to a processor, respective placement of one or more mid-circuit measurements and one or more classically controlled feed-forward operations on a quantum circuit to generate an optimized quantum circuit.

At 2704, the non-limiting method 2700 can comprise creating (e.g., by circuit twirling unit 110), by the system, twirled layers of circuit instructions based on the optimized quantum circuit by twirling respective classical bits that control the one or more classically controlled feed-forward operations.

At 2706, the non-limiting method 2700 can comprise inserting (e.g., by dynamical decoupling pulse sequence insertion unit 112), by the system, a dynamical decoupling pulse sequence during an idle duration and a context-switching duration of the optimized quantum circuit.

At 2708, the non-limiting method 2700 can comprise learning (e.g., by noise learning unit 116), by the system, a noise model of the twirled layers of circuit instructions based on a rank deficient Pauli transfer matrix to learn noise generated in the optimized quantum circuit.

At 2710, the non-limiting method 2700 can comprise identifying if any mid-circuit measurements can be placed in parallel.

If yes, at 2712, the non-limiting method 2700 can comprise placing as many mid-circuit measurements in parallel as possible.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively create error mitigated networks of conditional gates in quantum circuits as the one or more embodiments described herein can enable this process. And, neither can the human mind nor a human with pen and paper implement LOCC to execute virtual gates between QPUs, as conducted by one or more embodiments described herein.

One or more embodiments described herein can provide a number of advantages, including reducing error in feed-forward networks of conditional gates in larger quantum circuits towards implementation of virtual gates using LOCC, mitigating negative effects of lengthy measurements and context switches involved in implementing the virtual gates, and reduction in a cost of implementing the error mitigated virtual gates using LOCC. The error mitigated virtual gates with LOCC can enable modular quantum computers wherein multiple smaller QPUs can function as one big QPU by communicating through classical communications.

FIG. 28 illustrates a block diagram of an example, non-limiting operating environment 2800 in which one or more embodiments described herein can be facilitated. FIG. 28 and the following discussion are intended to provide a general description of a suitable operating environment 2800 in which one or more embodiments described herein at FIGS. 1-27 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 2800 contains an example of an environment for the execution of at least some of the computer code involved in performing the inventive methods, such as quantum error mitigation code 2845. In addition to block 2845, computing environment 2800 includes, for example, computer 2801, wide area network (WAN) 2802, end user device (EUD) 2803, remote server 2804, public cloud 2805, and private cloud 2806. In this embodiment, computer 2801 includes processor set 2810 (including processing circuitry 2820 and cache 2821), communication fabric 2811, volatile memory 2812, persistent storage 2813 (including operating system 2822 and block 2845, as identified above), peripheral device set 2814 (including user interface (UI), device set 2823, storage 2824, and Internet of Things (IoT) sensor set 2825), and network module 2815. Remote server 2804 includes remote database 2830. Public cloud 2805 includes gateway 2840, cloud orchestration module 2841, host physical machine set 2842, virtual machine set 2843, and container set 2844.

COMPUTER 2801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 2830. As is well understood in the art of computer technology, and depending upon the technology, performance of a computer-implemented method may be distributed among multiple computers and/or between multiple locations. On the other hand, in this presentation of computing environment 2800, detailed discussion is focused on a single computer, specifically computer 2801, to keep the presentation as simple as possible. Computer 2801 may be located in a cloud, even though it is not shown in a cloud in FIG. 28. On the other hand, computer 2801 is not required to be in a cloud except to any extent as may be affirmatively indicated.

PROCESSOR SET 2810 includes one, or more, computer processors of any type now known or to be developed in the future. Processing circuitry 2820 may be distributed over multiple packages, for example, multiple, coordinated integrated circuit chips. Processing circuitry 2820 may implement multiple processor threads and/or multiple processor cores. Cache 2821 is memory that is located in the processor chip package(s) and is typically used for data or code that should be available for rapid access by the threads or cores running on processor set 2810. Cache memories are typically organized into multiple levels depending upon relative proximity to the processing circuitry. Alternatively, some, or all, of the cache for the processor set may be located “off chip.” In some computing environments, processor set 2810 may be designed for working with qubits and performing quantum computing.

Computer readable program instructions are typically loaded onto computer 2801 to cause a series of operational steps to be performed by processor set 2810 of computer 2801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 2821 and the other storage media discussed below. The program instructions, and associated data, are accessed by processor set 2810 to control and direct performance of the inventive methods. In computing environment 2800, at least some of the instructions for performing the inventive methods may be stored in block 2845 in persistent storage 2813.

COMMUNICATION FABRIC 2811 is the signal conduction paths that allow the various components of computer 2801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 2812 is any type of volatile memory now known or to be developed in the future. Examples include dynamic type random access memory (RAM) or static type RAM. Typically, the volatile memory is characterized by random access, but this is not required unless affirmatively indicated. In computer 2801, the volatile memory 2812 is located in a single package and is internal to computer 2801, but, alternatively or additionally, the volatile memory may be distributed over multiple packages and/or located externally with respect to computer 2801.

PERSISTENT STORAGE 2813 is any form of non-volatile storage for computers that is now known or to be developed in the future. The non-volatility of this storage means that the stored data is maintained regardless of whether power is being supplied to computer 2801 and/or directly to persistent storage 2813. Persistent storage 2813 may be a read only memory (ROM), but typically at least a portion of the persistent storage allows writing of data, deletion of data and re-writing of data. Some familiar forms of persistent storage include magnetic disks and solid state storage devices. Operating system 2822 may take several forms, such as various known proprietary operating systems or open source Portable Operating System Interface type operating systems that employ a kernel. The code included in block 2845 typically includes at least some of the computer code involved in performing the inventive methods.

PERIPHERAL DEVICE SET 2814 includes the set of peripheral devices of computer 2801. Data communication connections between the peripheral devices and the other components of computer 2801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 2823 may include components such as a display screen, speaker, microphone, wearable devices (such as goggles and smart watches), keyboard, mouse, printer, touchpad, game controllers, and haptic devices. Storage 2824 is external storage, such as an external hard drive, or insertable storage, such as an SD card. Storage 2824 may be persistent and/or volatile. In some embodiments, storage 2824 may take the form of a quantum computing storage device for storing data in the form of qubits. In embodiments where computer 2801 is required to have a large amount of storage (for example, where computer 2801 locally stores and manages a large database) then this storage may be provided by peripheral storage devices designed for storing very large amounts of data, such as a storage area network (SAN) that is shared by multiple, geographically distributed computers. IoT sensor set 2825 is made up of sensors that can be used in Internet of Things applications. For example, one sensor may be a thermometer and another sensor may be a motion detector.

NETWORK MODULE 2815 is the collection of computer software, hardware, and firmware that allows computer 2801 to communicate with other computers through WAN 2802. Network module 2815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 2815 are performed on the same physical hardware device. In other embodiments (for example, embodiments that utilize software-defined networking (SDN)), the control functions and the forwarding functions of network module 2815 are performed on physically separate devices, such that the control functions manage several different network hardware devices. Computer readable program instructions for performing the inventive methods can typically be downloaded to computer 2801 from an external computer or external storage device through a network adapter card or network interface included in network module 2815.

WAN 2802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 2803 is any computer system that is used and controlled by an end user (for example, a customer of an enterprise that operates computer 2801), and may take any of the forms discussed above in connection with computer 2801. EUD 2803 typically receives helpful and useful data from the operations of computer 2801. For example, in a hypothetical case where computer 2801 is designed to provide a recommendation to an end user, this recommendation would typically be communicated from network module 2815 of computer 2801 through WAN 2802 to EUD 2803. In this way, EUD 2803 can display, or otherwise present, the recommendation to an end user. In some embodiments, EUD 2803 may be a client device, such as thin client, heavy client, mainframe computer, desktop computer and so on.

REMOTE SERVER 2804 is any computer system that serves at least some data and/or functionality to computer 2801. Remote server 2804 may be controlled and used by the same entity that operates computer 2801. Remote server 2804 represents the machine(s) that collect and store helpful and useful data for use by other computers, such as computer 2801. For example, in a hypothetical case where computer 2801 is designed and programmed to provide a recommendation based on historical data, then this historical data may be provided to computer 2801 from remote database 2830 of remote server 2804.

PUBLIC CLOUD 2805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 2805 is performed by the computer hardware and/or software of cloud orchestration module 2841. The computing resources provided by public cloud 2805 are typically implemented by virtual computing environments that run on various computers making up the computers of host physical machine set 2842, which is the universe of physical computers in and/or available to public cloud 2805. The virtual computing environments (VCEs) typically take the form of virtual machines from virtual machine set 2843 and/or containers from container set 2844. It is understood that these VCEs may be stored as images and may be transferred among and between the various physical machine hosts, either as images or after instantiation of the VCE. Cloud orchestration module 2841 manages the transfer and storage of images, deploys new instantiations of VCEs and manages active instantiations of VCE deployments. Gateway 2840 is the collection of computer software, hardware, and firmware that allows public cloud 2805 to communicate through WAN 2802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 2806 is similar to public cloud 2805, except that the computing resources are only available for use by a single enterprise. While private cloud 2806 is depicted as being in communication with WAN 2802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 2805 and private cloud 2806 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer-executable components; and
a processor that executes the computer-executable components stored in the memory, wherein the computer-executable components comprise:
a circuit transpiler unit that identifies respective placement of one or more mid-circuit measurements and one or more classically controlled feed-forward operations on a quantum circuit to generate an optimized quantum circuit;
a circuit twirling unit that creates twirled layers of circuit instructions based on the optimized quantum circuit by twirling respective classical bits that control the one or more classically controlled feed-forward operations; and
a noise learning unit that learns a noise model of the twirled layers of circuit instructions based on a rank deficient Pauli transfer matrix to learn noise generated in the quantum circuit.

2. The system of claim 1, wherein the circuit transpiler unit adapts a plurality of quantum gates and one or more classically controlled instructions of the quantum circuit to a hardware that executes the plurality of quantum gates and the one or more classically controlled instructions.

3. The system of claim 2, wherein adapting the plurality of quantum gates to the hardware comprises converting, with local operations, a classically controlled Z gate to a classically controlled X gate or converting the classically controlled X gate to the classically controlled Z gate.

4. The system of claim 1, wherein the twirled layers of circuit instructions comprise a plurality of mid-circuit measurements, a plurality of quantum gates and a plurality of feed-forward gates, and wherein the circuit twirling unit uses a set of twirling rules to twirl the respective classical bits that control the one or more classically controlled feed-forward operations.

5. The system of claim 4, wherein the set of twirling rules use the respective classical bits that control the one or more classically controlled feed-forward operations to ensure that one or more twirled classically controlled feed-forward operations have a logical effect as that of the one or more classically controlled feed-forward operations without twirling.

6. The system of claim 1, further comprising:
a dynamical decoupling pulse sequence insertion unit that inserts a dynamical decoupling pulse sequence during an idle duration and a context-switching duration of the quantum circuit.

7. The system of claim 6, wherein the dynamical decoupling pulse sequence insertion unit inserts the dynamical decoupling pulse sequence during the idle duration of the quantum circuit based on a sequence of dynamical decoupling gates.

8. The system of claim 1, wherein the learning of the noise model of the circuit instructions based on the rank deficient Pauli transfer matrix is performed via a Lasso regularization technique, and wherein the Lasso regularization technique is employed to minimize a strength of a generator that models noise in one or more circuit instructions.

9. A computer-implemented method, comprising:
identifying, by a system operatively coupled to a processor, respective placement of one or more mid-circuit measurements and one or more classically controlled feed-forward operations on a quantum circuit to generate an optimized quantum circuit;
creating, by the system, twirled layers of circuit instructions based on the optimized quantum circuit by twirling respective classical bits that control the one or more classically controlled feed-forward operations; and
learning, by the system, a noise model of the twirled layers of circuit instructions based on a rank deficient Pauli transfer matrix to learn noise generated in the optimized quantum circuit.

10. The computer-implemented method of claim 9, further comprising:
adapting, by the system, a plurality of quantum gates and one or more classically controlled instructions of the quantum circuit to a hardware that executes the plurality of quantum gates and the one or more classically controlled instructions.

11. The computer-implemented method of claim 9, further comprising:
using, by the system, a set of twirling rules to twirl the respective classical bits that control the one or more classically controlled feed-forward operations, wherein the twirled layers of circuit instructions comprise a plurality of mid-circuit measurements, a plurality of quantum gates and a plurality of feed-forward gates.

12. The computer-implemented method of claim 11, wherein the set of twirling rules use the respective classical bits that control the one or more classically controlled feed-forward operations to ensure that one or more twirled classically controlled feed-forward operations have a logical effect as that of the one or more classically controlled feed-forward operations without twirling.

13. The computer-implemented method of claim 9, further comprising:
inserting, by the system, a dynamical decoupling pulse sequence during an idle duration and a context-switching duration of the quantum circuit.

14. The computer-implemented method of claim 13, further comprising:
inserting, by the system, the dynamical decoupling pulse sequence during the idle duration of the quantum circuit based on a sequence of dynamical decoupling gates.

15. The computer-implemented method of claim 14, wherein the learning of the noise model of the circuit instructions based on the rank deficient Pauli transfer matrix is performed via a Lasso regularization technique, and wherein the Lasso regularization technique is employed to minimize a strength of a generator that models noise in one or more circuit instructions.

16. A computer program product for executing virtual gates with local operations and classical communication (LOCC), the computer program product comprising a computer readable storage medium having program instructions embodied therewith, the program instructions executable by a processor to cause the processor to:
identify, by the processor, respective placement of one or more mid-circuit measurements and one or more classically controlled feed-forward operations on a quantum circuit to generate an optimized quantum circuit;
create, by the processor, twirled layers of circuit instructions based on the optimized quantum circuit by twirling respective classical bits that control the one or more classically controlled feed-forward operations; and
learn, by the processor, a noise model of the twirled layers of circuit instructions based on a rank deficient Pauli transfer matrix to learn noise generate in the optimized quantum circuit.

17. The computer program product of claim 16, wherein the program instructions are further executable by the processor to cause the processor to:
adapt, by the processor, a plurality of quantum gates and one or more classically controlled instructions of the quantum circuit to a hardware that executes the plurality of quantum gates and the one or more classically controlled instructions.

18. The computer program product of claim 16, wherein the program instructions are further executable by the processor to cause the processor to:
use, by the processor, a set of twirling rules to twirl the respective classical bits that control the one or more classically controlled feed-forward operations, wherein the twirled layers of circuit instructions comprise a plurality of mid-circuit measurements, a plurality of quantum gates and a plurality of feed-forward gates.

19. The computer program product of claim 18, wherein the set of twirling rules use the respective classical bits that control the one or more classically controlled feed-forward operations to ensure that one or more twirled classically controlled feed-forward operations have a logical effect as that of the one or more classically controlled feed-forward operations without twirling.

20. The computer program product of claim 16, wherein the program instructions are further executable by the processor to cause the processor to:
insert, by the processor, a dynamical decoupling pulse sequence during an idle duration and a context-switching duration of the quantum circuit.
